(19) United States
(12) Patent Application Publication
(10) Pub. No.: US 2019/0250291 A1
(43) Pub. Date: Aug. 15, 2019

(54) METHOD AND SYSTEM FOR ACQUIRING PROBABILITY OF SLOPE FAILURE AND DESTABILIZATION CAUSED BY EARTHQUAKE

(71) Applicant: China University of Geosciences, Beijing, Beijing (CN)

(72) Inventors: Jinzhong Sun, Beijing (CN); Xuhui Zheng, Beijing (CN); Feng Xiong, Beijing (CN); Anyang Shao, Beijing (CN); Xiaofei Ge, Beijing (CN); Shaoyang Dai, Beijing (CN); Saichao Han, Beijing (CN); Jiemin Xu, Beijing (CN); Zhihua Liang, Beijing (CN)

(21) Appl. No.: 16/241,299

(22) Filed: Jan. 7, 2019

(30) Foreign Application Priority Data
Feb. 9, 2018 (CN) 201810131065.8

(51) Int. Cl. G01V 1/28; G06F 17/18; G01V 1/00

(52) U.S. Cl. CPC G01V 1/282; G06F 17/18; G01V 2210/675; G01V 1/008; G01V 2210/665; G01V 1/288

(57) ABSTRACT

A method and system are provided for acquiring the probability of slope failure and destabilization caused by an earthquake. For example, the method includes performing azimuth division in an area around a site at which a slope is located as a center, pre-setting a seismic acceleration threshold value that varies within a certain range, and calculating an exceeding probability that the seismic acceleration of the slope site generated by an earthquake in each azimuth domain is greater than or equal to the seismic acceleration threshold value, to establish an exceeding probability curve of site seismic acceleration corresponding to each azimuth domain. The method and system achieve estimation of the probability of slope destabilization caused by an earthquake by comprehensively considering the uncertainty of the seismic action and the uncertainty of slope failure and destabilization.

### CROSS-REFERENCE TO RELATED APPLICATION

This application claims priority to Chinese application number 201810131065.8, filed on Feb. 9, 2018. The above-mentioned patent application is incorporated herein by reference in its entirety.

### TECHNICAL FIELD

The present invention relates to the field of slope stability analysis, and in particular to a method and system for acquiring the probability of slope failure and destabilization caused by an earthquake.

### BACKGROUND

Currently, estimation of a probability of slope destabilization caused by an earthquake is mainly faced with the following problems:

(1) Estimation of possible future seismic actions does not take a potential orientation of hypocenter position and a mode of seismic action into account.

Currently, the probabilistic seismic hazard analysis result for estimating the probability of site seismic actions is obtained by superimposing combined effects of all potential epicenter positions in research areas around the site, which is the maximum seismic effect that the site might suffer in the future (the most unfavorable situation). Such an analysis result is conservative with respect to engineering seismic safety, i.e., uneconomical. Furthermore, the seismic action given by this analysis result only has acting intensity but has no acting direction, and further does not exhibit difference in site seismic actions caused by locations of potential hypocenter positions and types of seismic waves. Also, engineering structures and geotechnical slopes mostly have asymmetry, and different manners of seismic action may lead to different manners of failure and destabilization and different seismic damage outcomes. Therefore, it is very necessary to introduce a site seismic hazard analysis which considers azimuths of potential hypocenter positions, and to further consider effects of seismic action manners on slope failure and destabilization.

(2) The correlation between the determination of slope failure and destabilization and regional seismic activities is not intuitive enough.

When the seismic dynamic stability of a slope is considered, a traditional concept of slope static stability is substantially followed, where whether the rock-soil mass of a slope will be failed is judged by comparing the seismic dynamic stress suffered by the rock-soil mass of the slope and the intensity of the rock-soil mass. Although such an analytical determination conforms to the mechanics principle, the criterion for the seismic stability of the slope is limited to the micromechanics process and inner mechanical state of the slope, and there is absence of the correlation between the seismic stability of the slope and the regional seismic activity. Therefore, it is difficult to organically integrate the possibility of seismic actions obtained from site seismic hazard analysis with the possibility of slope failure and destabilization caused by an earthquake, and it is more difficult to estimate the probability of slope destabilization caused by an earthquake.

The estimation of the probability of slope destabilization caused by an earthquake involves two aspects: one is the possibility of the slope being subjected to seismic dynamic action; and the other is the slope destabilization manner under such kind of seismic dynamic actions and its possibility. The key of the problem is how to estimate the probability of slope destabilization caused by an earthquake by comprehensively considering the uncertainty of the seismic action and the uncertainty of slope failure and destabilization. Up to now, there is still no good way to solve this problem.

Thus, it would be desirable to provide a method and system for acquiring the probability of slope failure and destabilization caused by an earthquake, to estimate the probability of slope destabilization caused by an earthquake and a coefficient of slope seismic stability by comprehensively considering the uncertainty of the seismic action and the uncertainty of slope failure and destabilization.

### SUMMARY

To achieve the above object, the present invention provides the following solutions: A method for acquiring a probability of slope failure and destabilization caused by an earthquake, including: performing azimuth division in an area around where a slope is located as a center, to obtain different azimuth domains; pre-setting a seismic acceleration threshold value that varies within a certain range, and calculating the exceeding probability that the seismic acceleration of the slope site generated by an earthquake in each azimuth domain is greater than or equal to the seismic acceleration threshold value, to establish an exceeding probability curve of site seismic acceleration corresponding to each azimuth domain; establishing a numerical model of the slope; analyzing the anti-seismic capacity of the slope to a given seismic action manner by numerical simulation with the numerical model of the slope, to obtain slope critical seismic accelerations corresponding to different azimuth domains; and determining a probability of slope failure and destabilization caused by an earthquake according to the exceeding probability curve of slope-site seismic acceleration and the slope critical seismic accelerations associated with an azimuth domain.

In one aspect, the step of pre-setting a seismic acceleration threshold value that varies within a certain range, and calculating the exceeding probability that the seismic acceleration of the slope site generated by an earthquake in each azimuth domain is greater than or equal to the seismic acceleration threshold value, to establish an exceeding probability curve of site seismic acceleration corresponding to each azimuth domain specifically include: pre-setting a seismic acceleration threshold value that varies within a certain range; acquiring magnitudes, numbers and epicenter positions of potential earthquakes probably occurring in each azimuth domain in a given period of time in the future according to the data about historical and current earthquake activities in each azimuth domain; and establishing earthquake recurrence law for each azimuth domain describing the relationship between magnitudes and numbers of potential earthquakes in each azimuth domain within a certain period of time in the future; establishing an earthquake annual occurrence rate matrix corresponding to each azimuth domain based on the earthquake recurrence law established above, where the matrix is set up with a frame of earthquake magnitudes (the grading of magnitude sequence) and epicentral distances (the grading of distance sequence); establishing seismic attenuation law, describing the relationship between earthquake influence intensities and epicentral distances, for each azimuth domain from the data of historical seismic intensities and current earthquake ground motion records; establishing an earthquake influence intensity matrix of each azimuth domain based on the seismic attenuation law established above, where the matrix is also set up with the same frame of earthquake magnitudes and epicentral distances as that used in the earthquake annual occurrence rate matrix; searching all elements greater than or equal to a given pre-set threshold seismic acceleration in the earthquake influence intensity matrix of each azimuth domain, and finding the relative elements in the earthquake annual occurrence rate matrix of the same azimuth domain with the same magnitudes and the same distances as those elements greater than or equal to the given pre-set threshold seismic acceleration in the earthquake influence intensity matrix with, furthermore, adding up these elements of earthquake annual occurrence rates to obtain the exceeding rate of earthquake influence intensity to the given threshold seismic acceleration; making the given seismic acceleration threshold vary within a value domain thereof, to obtain an exceeding rate curve of earthquake influence intensity for a site corresponding to the azimuth domain; and according to the concept of safety and risk of a disaster-bearing body, by considering the engineering service life of the disaster-bearing body, converting the exceeding rate of earthquake influence intensity for the site into an exceeding probability of site seismic acceleration, to obtain an exceeding probability curve of site seismic acceleration.

In some embodiments, the establishing the numerical model of the slope specifically includes: establishing an initial numerical model of the slope based on the actual geology and topography of the slope; and adjusting the parameters of the initial numerical model of the slope to make the micro-vibration response-simulated spectrums of adjusted numerical model of the slope close enough to actually measured microtremor spectrums of the slope, to determine a numerical model of the slope.

In another aspect, the step of analyzing the anti-seismic capacity of the slope to a given seismic action manner by numerical simulation with the numerical model of the slope, to obtain slope critical seismic accelerations corresponding to different azimuth domains specifically includes: carrying out mesh generation on the numerical model of the slope, where an intersection point of meshes is a node, the bottom portion of the slope model is an excitation boundary, and a node on the excitation boundary is an excitation point at which a seismic wave incomes; acquiring the seismic dynamic action time histories at respective nodes on the excitation boundary at the bottom of the numerical model of the slope according to relevant influencing factors; where the relevant influencing factors include the seismic phase of the incident wave, the incident angle of the incident wave, the azimuth angle of the incident wave, and the propagation speed of the incident wave; calculating the initial value of the critical seismic peak acceleration for slope seismic stability by using a pseudo-static method; based on the principle of ensuring that the slope does not suffer from destabilization caused by dynamic failure, appropriately reducing the initial value of the critical seismic peak acceleration of the slope as calculated by the pseudo-static method, and taking the reduced initial value of the critical seismic peak acceleration as the maximum amplitude of the seismic dynamic action time history to determine the given seismic dynamic action time history for searching the critical seismic acceleration of the slope; gradually increasing the amplitude value of the given seismic dynamic action time history according to an increased amplitude as set, applying the seismic dynamic action time history with the increased amplitude to each node on the excitation boundary at the bottom of the numerical model of the slope according to timing of node starting, and calculating and simulating the seismic dynamic response of the slope corresponding to each step of amplitude increasing by using the dynamic time history method until the slope is subjected to failure and destabilization, thereby obtaining the critical seismic dynamic action time history of the slope; and taking the peak value of the obtained critical seismic dynamic action time history of the slope as the critical seismic acceleration of the slope corresponding to the given seismic dynamic action time history.

In yet another aspect, the step of acquiring the seismic dynamic action time histories at respective nodes on the excitation boundary at the bottom of the numerical model of the slope according to relevant influencing factors specifically includes: establishing a local coordinate system for the numerical model of the slope, where the setting of the local coordinate system (x, y, z) for the slope model is that: the x and y axes are located in the horizontal plane where the excitation boundary at the bottom of the slope is located, the x or y axis is along a direction with the maximum gradient of the slope, the z axis is vertically upward, the three axes of x, y and z are orthogonal to each other to form a right-hand rectangular coordinate system, the coordinate origin o is located at the node that is earliest disturbed by the seismic waves than any other nodes on the excitation boundary of the slope if the seismic waves are not vertically incident onto the excitation boundary of the slope, and this node is called the initial motion point of the slope seismic motion, otherwise, the coordinate origin o will be put at the node on the left corner of the excitation boundary opposite to the slope surface; calculating stress components of incident waves of different seismic phases according to the incident angles and the azimuth angles of the incident waves; where the different seismic phases include a P wave, an SV wave and an SH wave; calculating the start timing of the seismic disturbances at respective nodes on the excitation boundary at the bottom of the slope according to the incident angle of the incident wave, the azimuth angle of the incident wave and the propagation speed of the incident wave; and acquiring the seismic dynamic action time histories at respective nodes on the excitation boundary at the bottom of the numerical model of the slope according to the stress components of incident waves of different seismic phases and the start timing of the seismic disturbances at respective nodes on the excitation boundary at the bottom of the slope.

In a further aspect, the step of calculating stress components of incident waves of different seismic phases according to the incident angles and the azimuth angles of the incident waves specifically includes: calculating displacement components of incident waves of different seismic phases according to the incident angles and the azimuth angles of the incident waves; and calculating stress components of incident waves of different seismic phases according to the displacement components of the incident waves of different seismic phases.

In one aspect, the step of calculating the start timing of the seismic disturbances at respective nodes on the excitation boundary at the bottom of the slope according to the incident angle of the incident wave, the azimuth angle of the incident wave and the propagation speed of the incident wave specifically includes: calculating the propagation distance of the wavefront of the seismic wave by using the equation (1):

rᵢⱼ=lᵢⱼ·sin θ

lᵢⱼ=i·Δx·cos α+j·Δy·sin α (1)

where, rᵢⱼ is the propagation distance that the wavefront of the seismic wave passes through from the initial motion point of the slope (i.e., the origin of the local coordinate system of the slope model) to the node (i,j) along the propagation direction of the seismic wave, lᵢⱼ is the apparent distance on the excitation boundary at the bottom of the slope corresponding to the propagation distance rᵢⱼ of the wavefront of the seismic wave, Δx is the grid-edge length in the x-axis direction, Δy is the grid-edge length in the y-axis direction, θ is the incident angle of the seismic wave, and a is the azimuth angle of the seismic wave; calculating the time points at which the seismic waves of different seismic phases reach respective nodes on the excitation boundary at the bottom of the numerical model of the slope by using equation (2) according to the propagation distance of the wavefront of the seismic wave;

$${t}_{ij} = {t}_{0} + \frac{{r}_{ij}}{c} = {t}_{0} + \frac{i \cdot Δ x \cdot cos α + j \cdot Δ y \cdot sin α}{c} \cdot sin θ ; \qquad ( 2 )$$

where, tᵢⱼ is the time point at which the seismic wave of the seismic phase reaches the node (i,j) on the excitation boundary at the bottom of the slope; t₀ is time point at which the seismic wave of the seismic phase reaches the initial motion point on the excitation boundary at the bottom of the slope and is determined according to the distance from the potential hypocenter position to the slope site and the propagation speed of the seismic wave of the seismic phase in a regional crust; and c is an elastic wave velocity of a medium below the excitation boundary of the slope, which is expressed as c_{P} when the wave is a longitudinal wave, and is expressed as c_{S} when the wave is a transverse wave; and where the time points at which the seismic waves of different seismic phases reach respective nodes on the excitation boundary at the bottom of the slope, as calculated by equation (2), are the start timing of the seismic disturbances of different seismic phases at respective nodes on the excitation boundary at the bottom of the slope.

In another aspect, the step of acquiring the seismic dynamic action time histories at respective nodes on the excitation boundary at the bottom of the numerical model of the slope according to the stress components of incident waves of different seismic phases and the start timing of the seismic disturbances at respective nodes on the excitation boundary at the bottom of the slope specifically includes: superposing the stress component time histories generated by seismic waves of different seismic phase successively arriving at respective nodes according to the start timing of the seismic wave disturbances of different seismic phases at respective nodes on the excitation boundary at the bottom of the slope, namely, taking the algebraic sum of the same stress components corresponding to different seismic phases at respective time points in the duration of the seismic disturbance at each excitation node, to obtain the seismic dynamic action time history of each node on the excitation boundary at the bottom of the slope.

A system for acquiring a probability of slope failure and destabilization caused by an earthquake, including: an azimuth division module, configured for performing azimuth division in an area around a site at which a slope is located as a center, to obtain different azimuth domains; a module for calculating the exceeding probability of site seismic acceleration, configured for pre-setting a seismic acceleration threshold value that varies within a certain range, and calculating an exceeding probability that the seismic acceleration of the slope site generated by an earthquake in each azimuth domain is greater than or equal to the seismic acceleration threshold value, to establish an exceeding probability curve of site seismic acceleration corresponding to each azimuth domain; a module for establishing a slope numerical model, configured for establishing a numerical model of the slope; a module for calculating a slope critical seismic acceleration, configured for acquiring slope critical seismic accelerations corresponding to different seismic action manners acting on the slope numerical model; where the seismic action manners include the intensity, frequency and duration of the seismic motion as well as the nature, directions and phase differences of the seismic action forces, and the relevant influencing factors mainly include the seismic phase of the incident wave, the incident angle of the incident wave, the azimuth angle of the incident wave, and the propagation speed of the incident wave; and a module for calculating a probability of slope failure and destabilization caused by an earthquake, configured for determining a probability of slope failure and destabilization caused by an earthquake according to the exceeding probability curve of slope-site seismic acceleration and the slope critical seismic accelerations, and calculating a slope seismic stability coefficient.

According to specific embodiments provided in the present invention, the present invention discloses the following technical effects: The present invention discloses a method and system for acquiring the probability of slope failure and destabilization caused by an earthquake, including: first determining an exceeding probability curve of site seismic acceleration corresponding to each azimuth domain around a slope; then determining a critical seismic acceleration for the slope failure and destabilization according to actual geology and topography of the slope; and finally determining the probability of slope failure and destabilization according to the exceeding probability curve of site seismic acceleration and the critical seismic acceleration of the slope, which comprehensively considers the uncertainty of the seismic action and the uncertainty of slope failure and destabilization, to realize estimation of the probability of slope destabilization caused by an earthquake.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitute a part of this specification, illustrates one or more embodiments of the invention and, together with the general description given above and the detailed description given below, explains the one or more embodiments of the invention.

FIG. 1 is a flow chart of a method for acquiring a probability of slope failure and destabilization caused by an earthquake provided according to one embodiment of the present invention.

FIG. 2 is an azimuth division diagram of the method of FIG. 1.

FIG. 3 is a graph showing an exceeding rate curve of slope-site seismic acceleration according to the method of FIG. 1.

FIG. 4 is a graph showing an exceeding probability curve of slope-site seismic acceleration according to the method of FIG. 1.

FIG. 5 is a diagram showing a correspondence relationship between a slope critical seismic acceleration and a probability of slope failure and destabilization according to the method of FIG. 1.

FIG. 6 is a diagram showing the relationship between probabilities corresponding to a slope critical seismic acceleration and a fortification seismic acceleration when the slope seismic stability is very poor, as provided in one embodiment of the invention.

FIG. 7 is a diagram showing the relationship between probabilities corresponding to a slope critical seismic acceleration and a fortification seismic acceleration when the slope seismic stability is relatively poor, in another embodiment of the invention.

FIG. 8 is a diagram showing the relationship between probabilities corresponding to a slope critical seismic acceleration and a fortification seismic acceleration for a critical stable state, in one embodiment of the invention.

FIG. 9 is a diagram showing the relationship between probabilities corresponding to a slope critical seismic acceleration and a fortification seismic acceleration when the slope seismic stability is relatively good, in yet another embodiment.

FIG. 10 is a diagram showing the relationship between probabilities corresponding to a slope critical seismic acceleration and a fortification seismic acceleration when the slope seismic stability is very good, in a further embodiment.

FIG. 11 is a block diagram showing the configuration of a system for acquiring a probability of slope failure and destabilization caused by an earthquake according to one embodiment of the invention.

### DETAILED DESCRIPTION

An object of the present invention provides a method and system for acquiring the probability of slope failure and destabilization caused by an earthquake, to realize estimation of the probability of slope destabilization caused by an earthquake by comprehensively considering the uncertainty of the seismic action and the uncertainty of slope failure and destabilization.

To make the foregoing objective, features, and advantages of the present invention clearer and more comprehensible, the present invention is further described in detail below with reference to the accompanying drawings and specific embodiments.

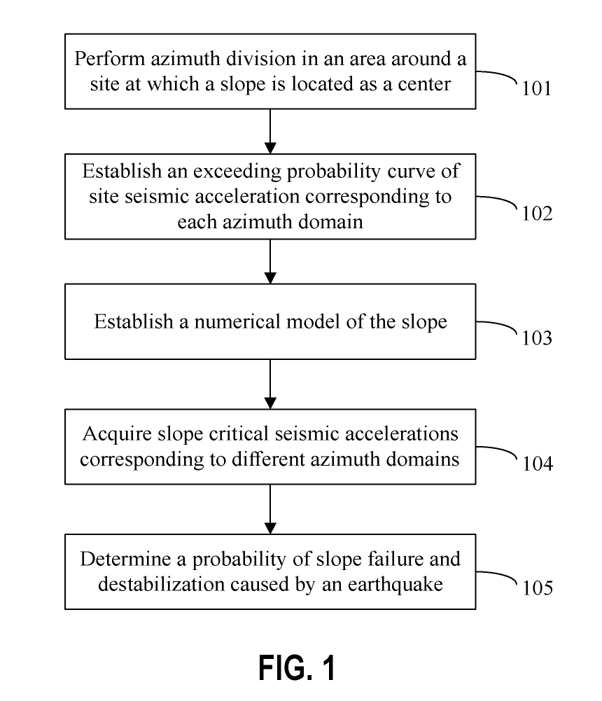

As shown in FIG. 1, the present invention provides a method for acquiring the probability of slope failure and destabilization caused by an earthquake, including: step 101: perform azimuth division in an area around a site at which a slope is located as a center, to obtain different azimuth domains; step 102: pre-set a seismic acceleration threshold value that varies within a certain range, and calculate an exceeding probability that the seismic acceleration of the slope site generated by an earthquake in each azimuth domain is greater than or equal to the seismic acceleration threshold value, to establish an exceeding probability curve of site seismic acceleration corresponding to each azimuth domain; step 103, establish a numerical model of the slope; step 104: analyze the anti-seismic capacity of the slope to a given seismic action manner by numerical simulation with the numerical model of the slope, to acquire slope critical seismic accelerations corresponding to different azimuth domains; and step 105: determine a probability of slope failure and destabilization caused by an earthquake according to the exceeding probability curve of slope-site seismic acceleration and the slope critical seismic accelerations associated with an azimuth domain.

Optionally, the step of pre-setting a seismic acceleration threshold value that varies within a certain range, and calculating the exceeding probability that the seismic acceleration of the slope site generated by an earthquake in each azimuth domain is greater than or equal to the seismic acceleration threshold value, to establish an exceeding probability curve of site seismic acceleration corresponding to each azimuth domain, as described in step 102, particularly includes: pre-setting a seismic acceleration threshold value that varies within a certain range; acquiring magnitudes, numbers and epicenter positions of potential earthquakes probably occurring in each azimuth domain in a given period of time in the future according to the data about historical and current earthquake activities in each azimuth domain; and establishing earthquake recurrence law for each azimuth domain describing the relationship between magnitudes and numbers of potential earthquakes in each azimuth domain within a certain period of time in the future; establishing an earthquake annual occurrence rate matrix corresponding to each azimuth domain based on the earthquake recurrence law established above, where the matrix is set up with a frame of earthquake magnitudes (the grading of magnitude sequence) and epicentral distances (the grading of distance sequence); establishing seismic attenuation law, describing the relationship between earthquake influence intensities and epicentral distances, for each azimuth domain from the data of historical seismic intensities and current earthquake ground motion records; establishing an earthquake influence intensity matrix of each azimuth domain based on the seismic attenuation law established above, where the matrix is also set up with the same frame of earthquake magnitudes and epicentral distances as that used in the earthquake annual occurrence rate matrix; searching all elements greater than or equal to a given pre-set threshold seismic acceleration in the earthquake influence intensity matrix of each azimuth domain, and finding the relative elements in the earthquake annual occurrence rate matrix of the same azimuth domain with the same magnitudes and the same distances as those elements greater than or equal to the given pre-set threshold seismic acceleration in the earthquake influence intensity matrix with, furthermore, adding up these elements of earthquake annual occurrence rates to obtain the exceeding rate of earthquake influence intensity to the given threshold seismic acceleration; making the given seismic acceleration threshold vary within a value domain thereof, to obtain an exceeding rate curve of earthquake influence intensity for a site corresponding to the azimuth domain; and according to the concept of safety and risk of a disaster-bearing body, by considering the engineering service life of the disaster-bearing body, converting the exceeding rate of earthquake influence intensity for the site into an exceeding probability of site seismic acceleration, to obtain an exceeding probability curve of site seismic acceleration.

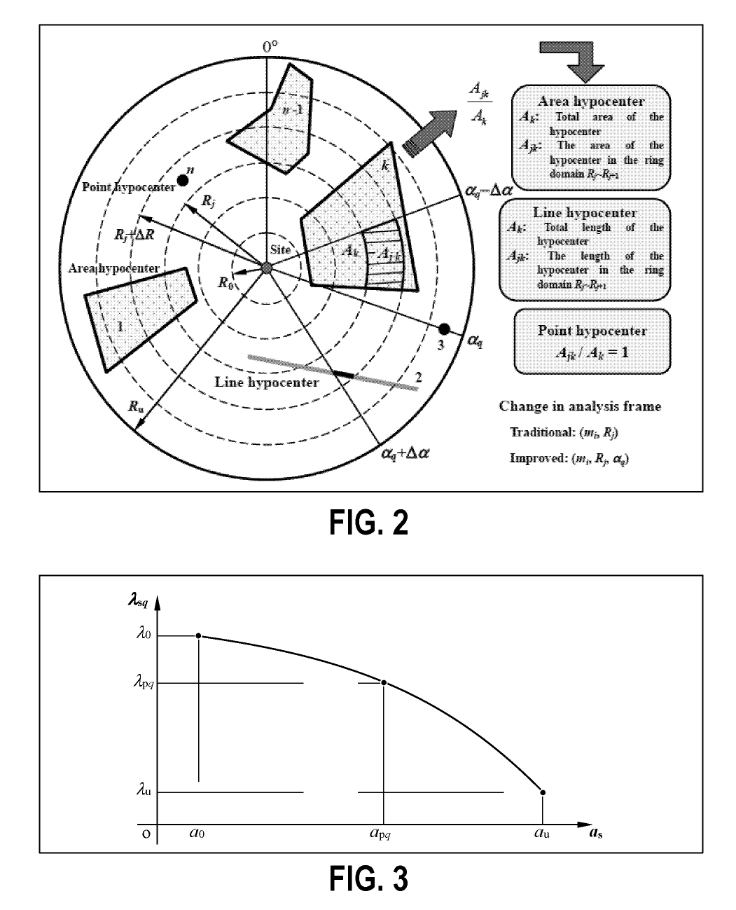

In particular, analysis of the exceeding probability of slope-site seismic acceleration is based on geological structures and regional seismic activities, and mainly includes several content parts, i.e., division of potential hypocenters, establishment of an earthquake annual occurrence rate matrix based on earthquake recurrence law, establishment of an earthquake influence intensity matrix based on a seismic attenuation law, and calculation of an exceeding probability of site seismic acceleration. Considering analysis of the exceeding probability of a site seismic action intensity for a potential hypocenter somewhere with an azimuth angle, it is necessary to further divide azimuth domains in the area around the site at which the slope site is located as the center, and to analyze seismic effects of potential hypocenters at respective azimuth domains on the site by considering the seismic recurrence law and the seismic attenuation law of representative potential hypocenter positions in respective azimuth domains, to acquire an exceeding probability curve of site seismic acceleration corresponding to respective azimuth domains in a certain period of time in future. The divided azimuth domains are as shown in FIG. 2, and the basic ideas and calculation methods of the analysis are as follows:

### (1) Classification and Numbering of Potential Hypocenters

As shown in FIG. 2, according to the spatial distribution of potential hypocenter positions within an earthquake-affected radius around the site (an earthquake-affected zone), the potential hypocenters are divided into four types: point hypocenters, line hypocenters, area hypocenters and diffusion hypocenters. Since the occurrence of the diffusion hypocenters is not clearly related to any seismic structures and is relatively weak, it will not be taken into account. A point hypocenter has a small area and its seismogenic positions are relatively concentrated, such as an intersection of large active faults; a line hypocenter refers to the distribution of potential epicenters along a corridor, and is mostly related to rupture of active structures; and an area hypocenter describes a situation in which earthquake may occur in a certain section in future, and may correspond to an area where the active faults are dense and the tectonic activity is strong. After the potential hypocenters are demarcated, statistics of the number of potential hypocenters in the earthquake-affected zone is performed and the potential hypocenters are numbered. Let Sₖ represents the k-th hypocenter, where k is the serial number of a potential hypocenter, and it is assumed that there are n potential hypocenters in the earthquake-affected zone, then:

Sₖ, k=1,2, . . . ,n

### (2) Grading of Earthquake Magnitude Sequence mᵢ

The magnitude range [m₀, mᵤ] of potential hypocenters in the earthquake-affected zone is determined based on seismic activities in the earthquake-affected zone, where m₀ is a lower limit of the earthquake magnitude, and mᵤ is an upper limit of the earthquake magnitude:

m₀≥mᵢ≥mᵤ, i=0,1,2, . . . ,l

where, mᵢ varies by an increment of Δm=(mᵤ−m₀)/l (grading of earthquake magnitude intervals), and I is the number of intervals.

### (3) Grading of Distance Sequence Rⱼ

R₀≥Rⱼ≥Rᵤ, j=0,1,2, . . . ,m

where, Rⱼ varies by an increment of ΔR=(Rᵤ−R₀)/m (grading of distance intervals); R₀ can take the distance from a potential epicenter distance nearest to the slope site to the site; and Rᵤ is the epicenter distance from a potential hypocenter in the earthquake-affected zone farthest from the site to the center of the site, i.e., the radius of the earthquake-affected zone of the site.

### (4) Grading of Azimuth Sequence α_{q}

α_{q}ε[0°,360°], q=1,2, . . . ,p

where, α_{q} is a representative value of the q-th azimuth domain [α_{q}−Δα_{q}, α_{q}+Δα_{q}] with the engineering site as the vertex; α_{q} is the center value of the q-th azimuth domain; q is a positive integer, which represents a serial number for interval grading of a azimuth domain and can be referred to as an azimuth-interval grading counter; p is a positive integer, which represents the total number of azimuth domains divided according to distribution of potential hypocenters, with the engineering site as the center; and Δα=360°/(2p) is the half width of the q-th azimuth domain. For instance, if p=8, then the specific situation of 360° average grading of azimuth sequence is as shown in Table 1.

TABLE 1
Grading of azimuth intervals for potential hypocenters

| | | Azimuth | Azimuth |
|---|---|---|---|
| | | Sequence α_{q} | Domain |
| Azimuth | q | (°) | (°) |
| N | 1 | 0 | −22.5 to 22.5 |
| NE | 2 | 45 | 22.5 to 67.5 |
| E | 3 | 90 | 67.5 to 112.5 |
| SE | 4 | 135 | 112.5 to 157.5 |
| S | 5 | 180 | 157.5 to 202.5 |
| SW | 6 | 225 | 202.5 to 247.5 |
| W | 7 | 270 | 247.5 to 292.5 |
| NW | 8 | 315 | 292.5 to 337.5 |

### (5) Establishment of Earthquake Annual Occurrence Rate Matrix Based on Recurrence Law

Earthquake magnitudes and the number of earthquakes for earthquakes occurred in each azimuth domain in a set time are acquired according to the historical and the current seismic activity data in each azimuth domain; according to the earthquake data, the relationship between the earthquake magnitudes and the number of earthquakes for earthquakes occurred in a certain azimuth domain in a predetermined time T is calculated using the equation (3), to obtain the recurrence law;

lg N=a−bM (3)

or N(m)=e^{α-αm} (3′)

in the equations: M represents earthquake magnitude; N represents the total number of earthquakes with M≤m, m represents a taken value of the earthquake magnitude; and a, b, α and β each are statistical constants.

An earthquake annual occurrence rate matrix Λ_{α} corresponding to each azimuth domain α_{q} is established by using the equation (4) based on the recurrence law as shown in the equation (3), the matrix using the grading of magnitude sequence mᵢ and the grading of distance sequence Rⱼ as a frame:

Λ_{α}=[λ_{ijq}]_{n×m},α=α_{q}(q=1,2, . . . ,p) (4)

where, a matrix element λ_{ijq} is the average annual occurrence rate of an earthquake with the earthquake magnitude of mᵢ in an intersection zone Rⱼ∩α_{q} between the q-th azimuth domain α_{q} and the j-th ring domain Rⱼ in an earthquake-affected zone of the site in a period of time (time period) T.

### (6) Establishment of Earthquake Influence Intensity Matrix Based on Seismic Attenuation Law

The seismic attenuation law is defined as the law that the influence intensity (seismic acceleration or seismic intensity on a site) of an earthquake attenuates with the increase of epicenter distance.

The seismic attenuation law can be described by the relationship between horizontal seismic peak acceleration aₚ or seismic intensity of a site and an epicenter distance or hypocenter distance, which is expressed in a general form of:

aₚ=f(M,R) (5)

in the equation, M is the earthquake magnitude, and R is the epicenter distance or hypocenter distance of the site.

The attenuation law of the site seismic intensity Is is as follows:

Is=f(I₀,R) (6)

where, I₀ represents epicentral seismic intensity; and R represents the epicenter distance or hypocenter distance of the site.

Seismic parameters have quantitative significance for a seismic design, and usually it is relatively easy to obtain a seismic intensity attenuation law based on a large number of historical data of seismic activities. Therefore, it is necessary to establish the relationship between seismic parameters, i.e., between the horizontal seismic peak acceleration aₚ of the site and the site seismic intensity I_{S}. The statistical relationship between the site intensity and the peak acceleration is generally expressed in the following form:

ln aₚ=f(I_{S})=C₁+C₂I_{S}

ln aₚ=f(I_{S},R)=C₁+C₂I_{S}+C₃ ln R

ln aₚ=f(I_{S},M)=C₁+C₂I_{S}+C₃ ln M (7)

where, M is the earthquake magnitude, R is the hypocenter distance, and C₁ to C₃ are statistical constants.

By applying the equation (5) in the q-th azimuth domain, the strength of influence of the i-th magnitude interval, the j-th distance interval and the q-th azimuth interval on the site can be obtained as:

a_{ijkq}=fₖ(mᵢ,Rⱼ,α_{q}) (8)

The influences of hypocenters in the same distance interval of an angle domain are summed, then:

$${a}_{ijq} = {\sum }_{k = 1}^{l} {a}_{ijkq} , R ∈ [ Rj , {R}_{j + 1} ] , α = {α}_{q} ( q = 1 , 2 , … , p ) \qquad ( 9 )$$

Similarly, considering all the cases of different earthquake magnitudes and different epicenter distances in the frame, an earthquake influence intensity matrix A_{q} for potential hypocenters in different azimuth domains α_{q} of an earthquake-affected zone of a site can be established by using the seismic influence intensity parameters (horizontal seismic peak accelerations) shown in the equation (9) as elements:

A_{q}=[a_{ijq}]_{n×m} (10)

The elements of the earthquake influence intensity matrix are the seismic peak accelerations (also may be the site seismic intensities) generated at a site under the influence of potential hypocenters in different azimuth domains ca, which reflects the intense degree of the influences of earthquakes with different distances, different magnitudes and different azimuths in a certain period in future on the slope site.

### (7) Earthquake Influence Intensity and its Exceeding Probability

The earthquake influence exceeding probability Pₛ is defined as the possibility of the influence intensity aₚ of seismic action suffered by a site in a certain period of time Tin the future is greater than or equal to a seismic intensity threshold, i.e., the possibility of the event aₚ≥aₛ.

In order to obtain the earthquake influence exceeding probability P_{sq} of a site in a certain period of time T in the future caused by an earthquake in an azimuth domain α_{q}, the earthquake-influence exceeding rate, namely the annual occurrence rate λ_{sq} that the influence intensity a_{pq} of the earthquake from the azimuth angle α_{q} suffered by the site in a certain period of time T in the future is greater than or equal to the seismic acceleration threshold aₛ, i.e., the annual occurrence rate of the event a_{pq}≥aₛ, is calculated based on the comparison of the earthquake influence intensity matrix and the earthquake annual occurrence rate matrix; and then, the earthquake influence exceeding rate is converted to the earthquake influence exceeding probability according to the concepts of safety and risk of the disaster-bearing body (such as a slope), in considering the engineering service life T of the disaster-bearing body.

The earthquake influence intensity matrix A_{q}=[a_{ijq}] is searched for all of elements a_{sijq} which satisfy the condition a_{ijq}≥aₛ:

[a_{sijq}][a_{ijq}|a_{ijq}≥aₛ] (11)

The corresponding elements λ_{sijq} in the earthquake annual occurrence rate matrix Λ_{q}=[λ_{ijq}] are added up to obtain an exceeding rate λ_{sq}:

$${λ}_{sq} = {\sum }_{i , j} {λ}_{sijq} \qquad ( 12 )$$

Let aₛ∈[a₀, aᵤ] and correspond to λ_{sq}, a curve λ_{sq}−aₛ is obtained, i.e., the exceeding rate curve, as shown in the equation (13) and FIG. 3.

λ_{sq}=f(aₛ),aₛ∈[a₀,aᵤ] (13)

The curve of earthquake-influence annual exceeding rate (λ_{sq}−aₛ) expressed in the equation (13) and FIG. 3 is the final result of analyzing the earthquake influences (seismic hazard) from different directions (α_{q}) that may be suffered by a site, and this result is established on the basis of the earthquake recurrence law and the seismic attenuation law, which reflects the uncertainty of earthquake occurrence. The curve of earthquake-influence annual exceeding rate can be understood from two aspects: one is specifying the fortification requirements of a site for an earthquake coming from the azimuth α_{q}—the earthquake influence intensity a_{pq}, to determine a corresponding annual exceeding rate λ_{pq}; and the other is specifying the allowable hazard level of the site on the azimuth α_{q}—earthquake annual exceeding rate λ_{pq}, to determine a corresponding earthquake influence level a_{pq}.

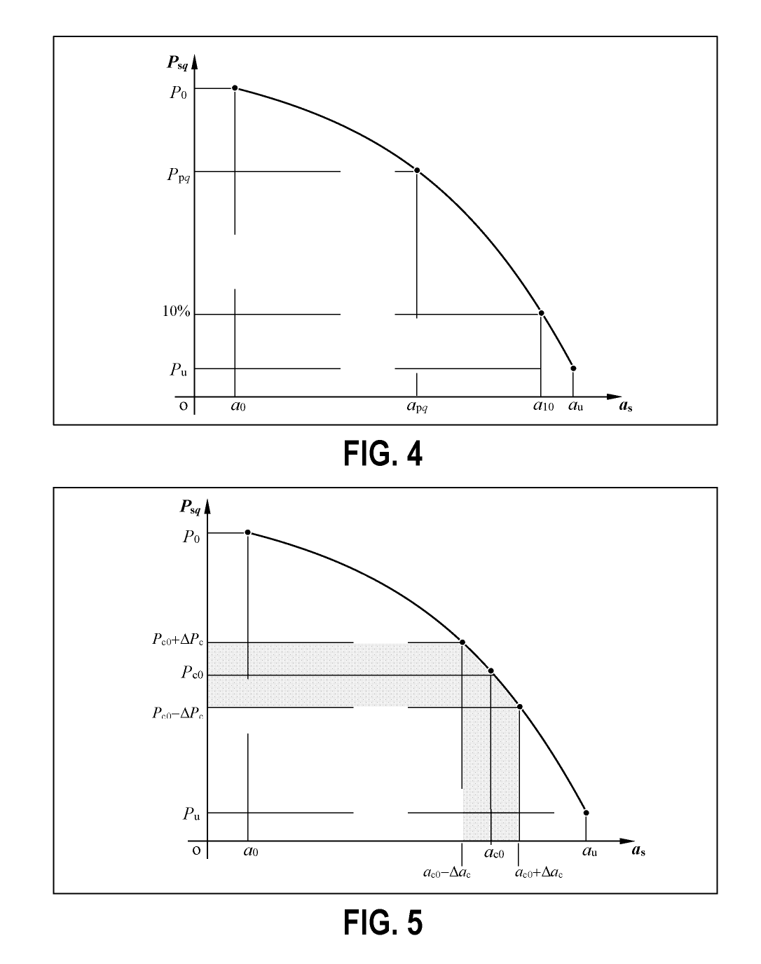

Furthermore, based on the concept of safety and risk of the disaster-bearing body (such as a slope), in considering the engineering service life T of the disaster-bearing body, the curve (λ_{sq}−aₛ) of earthquake influence annual exceeding rate for the site can be converted to the curve (P_{sq}−aₛ) of the exceeding probability (P_{sq}) that the disaster-bearing body suffers a certain intensity of earthquake influence (aₛ) as shown in FIG. 4. The conversion formula is as shown in equation (14):

P_{sq}=P[n≥1|a_{pq}≥aₛ,T]=1−e^{-λsq·T} (14)

in the equation, P[n≥1|a_{pq}≥aₛ, T] represents the probability of occurrence of the event a_{pq}≥aₛ in a time period Tin future.

Optionally, the step of establishing the numerical model of the slope specifically includes: establishing an initial numerical model of the slope based on the actual geology and topography of the slope; and in particular, constructing a slope profile according to geographic and geomorphic conformations of the slope; constructing an internal structure of the numerical model of the slope according to the geological structure of the slope; constructing a medium for the numerical model of the slope by using a constitutive relation that conforms to the physical and mechanical properties of the material composition of the slope, and setting a contact relationship between different media masses in the slope body according to a mechanical principle; and setting a cutoff boundary (which is generally located at the periphery of the model on a plumb surface, disconnects the slope body from surrounding geological bodies, and is set as a transmission boundary, or is called a free field boundary) and an excitation boundary (which is generally located at the bottom of the slope on a horizontal plane, and is set as a static boundary) of the slope model according to seismic dynamic responses and requirements of wave field simulation of the slope body, and performing mesh generation on the slope body (the size of a mesh should be less than 1/10 to ⅛ of a wavelength corresponding to the highest frequency of the input seismic wave) to obtain an initial slope model.

Adjusting the parameters of the initial numerical model of the slope to make the micro-vibration response-simulated spectrum of adjusted numerical model of the slope close enough to actually measured microtremor spectrums of the slope, to determine a numerical model of the slope.

In particular, the purpose of the fit between the micro-vibration response-simulated spectrums of adjusted numerical model of the slope and the actually measured microtremor spectrums of the slope is to adjust parameters of the slope, thereby making the dynamic characteristics of the numerical model of the slope be consistent with the actual dynamic characteristics of the slope. The micro-vibration spectrum fitting of the slope model uses the actually measured microtremor amplitude spectrum obtained from the actual measurement of the slope microtremors, obtains the micro-vibration spectrum of the slope model via a broad-spectrum micro-vibration excitation onto the slope model, compares the micro-vibration spectrums of the slope model (simulated spectrum) with the actually measured microtremor spectrums of the slope (actually measured spectrum), and repeatedly adjusts parameters of the slope model (physical property parameters and structural parameters) according to the difference between the simulated spectrums and the actually measured spectrums, so that the simulated spectrums are continually approaching the actually measured spectrums (in particular, approaching of the predominant frequency of the simulated spectrums to the predominant frequency of the actually measured spectrums), thereby achieving the purpose of matching the dynamic characteristics of the slope model with the dynamic characteristics of the actual slope.

The micro-vibration spectrum fitting of the slope model can be divided into three technical links: measurement of the actual slope microtremors, analysis of the micro-vibration spectrums of the slope model, and fitting and parameter adjusting.

Microtremor is a weak continuous random vibration of rock-soil mass ground of a site under the excitation of non-single and uncertain vibration sources (including natural factors such as earthquakes, wind vibrations, volcanic activities, ocean waves, etc.; and human factors such as traffic, dynamic machines, engineering construction, etc.). Due to complexity of excitation sources, the microtremor is equivalent to the dynamic response of the rock-soil mass ground of the site to white-noise excitation. The actually measured microtremor spectrum V_{S}(x, y, z, f) (the relationship between an amplitude V_{S} and a frequency f of a microtremor single-frequency component at respective points (x, y, z) of the slope body) can be obtained by conducting Fourier analysis of the actually measured microtremor time histories of the slope. According to the resonance principle, the predominant frequency of the microtremor spectrum is very close to the natural vibration frequency of the rock-soil mass ground of the site. Therefore, the actually measured spectrum of the slope obtained from measurement of the slope microtremor can be regarded as the objective function for fitting the dynamic characteristics of the numerical model of the slope.

The measurement of the slope microtremors can be carried out by referring to the relevant provisions of “Code for measurement methods of dynamic properties of subsoil” (GB/T 50269-2015). The measuring line for actually measuring the slope microtremors should be arranged according to actual geological and topographic features of the slope, with the principle of capturing the vibration mode of the slope as comprehensively as possible.

It is assumed that the micro-vibration spectrum of the slope model is

V_{Mi}(x,y,z,f), i=0,1,2, . . . ,n

where, i represents the number of times of adjusting parameters of the slope model; the micro-vibration spectrum V_{M0}(x, y, z, f) corresponding to i=0 is a micro-vibration response spectrum of the initial slope model, and by analogy, the micro-vibration spectrum V_{M1}(x, y, z, f) corresponding to i=1 is a micro-vibration response spectrum of the slope model after the first time of parameter adjustment, . . . , and the micro-vibration spectrum V_{Mn}(x, y, z, f) corresponding to i=n is a micro-vibration response spectrum of the slope model after the n-th time of parameter adjustment.

By comparing the difference between the simulated spectrum (the micro-vibration spectrum of the initial slope model and the corresponding micro-vibration spectrum of the slope model after each time of parameter adjustment) with the actually measured spectrum (the actually microtremor spectrum of the slope), the difference ΔV_{Msi} between the simulated spectrum after each time of parameter adjustment and the actually measured spectrum is investigated:

ΔV_{MSi}(x,y,z,f)=|V_{Mi}(x,y,z,f)−V_{S}(x,y,z,f)| (15)

By adjusting the parameters repeatedly, when after a certain time of parameter adjustment (i=n), as the micro-vibration response of the slope model satisfies equation (16)

ΔV_{MSn}(x,y,z,f)≥δ (16)

it can be considered that the dynamic characteristics of the slope model are consistent enough with the dynamic characteristics of the actual slope. The slope model formed after this time of parameter adjustment is the model for confirming a slope which meets the requirements of dynamic characteristics. In the above equation, 6 is a small variable determined according to the degree to which the dynamic characteristics of the slope model fit the dynamic characteristics of the actual slope.

In the process of fitting and parameter adjusting of the micro-vibration spectrum of the slope model as described above, the range of comparison between the simulated spectrum and the measured spectrum theoretically should be at all spatial points (point-by-point comparison) and all frequency components (comparison of respective frequency components) of the slope body. That is, the definition domain of equation (15) is: spatial points (x, y, z) are distributed throughout the slope body; and the frequency f covers all effective frequencies of microtremors. However in fact, it is not possible to arrange the measuring points for actually measuring the slope microtremors all over the spatial points of the slope body, and the measuring points can only be arranged on measuring lines with certain representative significance on the surface of the slope body, and thus the comparison between the simulated spectrum and the actually measured spectrum as expressed by equation (15) can only be limited on these measuring lines. Therefore, it is an issue deserving special attention that when actual measurement of the slope microtremors is conducted, the selective arrangement of measuring lines can effectively reflect the dynamic characteristics of the slope body. Since the predominant frequency in the spectrum can reflect the natural vibration characteristics of the slope, special attention should be paid to the comparing and fitting of predominant frequencies for comparison between the simulated spectrum and the actually measured spectrum in the frequency domain.

Optionally, the step of analyzing the anti-seismic capacity of the slope to a given seismic action manner by numerical simulation with the numerical model of the slope, to obtain slope critical seismic accelerations corresponding to different azimuth domains specifically includes: carrying out mesh generation on the numerical model of the slope, where an intersection point of meshes is a node, the bottom portion of the slope model is an excitation boundary, and a node on the excitation boundary is an excitation point at which a seismic wave incomes; acquiring the seismic dynamic action time histories at respective nodes on the excitation boundary at the bottom of the numerical model of the slope according to relevant influencing factors; where the relevant influencing factors include the seismic phase of the incident wave, the incident angle of the incident wave, the azimuth angle of the incident wave, and the propagation speed of the incident wave; calculating the initial value of the critical seismic peak acceleration for slope seismic stability by using a pseudo-static method; based on the principle of ensuring that the slope does not suffer from destabilization caused by dynamic failure, appropriately reducing the initial value of the critical seismic peak acceleration of the slope as calculated by the pseudo-static method, and taking the reduced initial value of the critical seismic peak acceleration as the maximum amplitude of the seismic dynamic action time history to determine the given seismic dynamic action time history for searching the critical seismic acceleration of the slope; gradually increasing the amplitude value of the given seismic dynamic action time history according to an increased amplitude as set, applying the seismic dynamic action time history with the increased amplitude to each node on the excitation boundary at the bottom of the numerical model of the slope according to timing of node starting, and calculating and simulating the seismic dynamic response of the slope corresponding to each step of amplitude increasing by using the dynamic time history method until the slope is subjected to failure and destabilization, thereby obtaining the critical seismic dynamic action time history of the slope; and taking the peak value of the obtained critical seismic dynamic action time history of the slope as the critical seismic acceleration of the slope corresponding to the given seismic dynamic action time history.

In particular, broadly the manner of seismic action should include the intensity, frequency, duration of the seismic action, and the nature and direction of the seismic force. Additionally, oblique incident seismic wave will cause unsynchronized starts of seismic disturbances at different nodes on the excitation boundary at the bottom of the earthquake-affected slope (which can be extended to a general engineering body), and result in the phase difference of seismic disturbance, thereby changing the distribution state of fluctuating stress and dynamic deformation within the slope body. Therefore, the start timing of seismic disturbance at different positions on the excitation boundary at bottom of the slope body should also be one aspect of the manner of seismic action. The intensity, frequency and duration of a seismic action are summarized as well-known “three factors of seismic motion (intensity, frequency and duration)” in the field of engineering seismology. Therefore, the “manner of seismic action (in a narrow sense)” mentioned in the present invention mainly refers to the phase difference (start timing) of the seismic motion and the nature and direction of the seismic force, which are supplements to the traditional “three factors of seismic motion” and can called as the fourth and fifth factors of seismic motion. Obviously, the fourth and fifth factors of seismic motion cannot be ignored for the seismic failure of an engineering body. The earthquake action manners proposed by the present invention are embodied as the start timing of the seismic disturbance at different nodes on the excitation boundary at the bottom of the slope and the dynamic stress components of respective nodes caused by the oblique incident seismic waves.

Optionally, the step of acquiring the seismic dynamic action time histories at respective nodes on the excitation boundary at the bottom of the numerical model of the slope according to relevant influencing factors specifically includes: establishing a local coordinate system for the numerical model of the slope; where the setting of the local coordinate system (x, y, z) for the slope model is that: the x and y axes are located in the horizontal plane where the excitation boundary at the bottom of the slope is located, the x or y axis is along a direction with the maximum gradient of the slope, the z axis is vertically upward, the three axes of x, y and z are orthogonal to each other to form a right-hand rectangular coordinate system, the coordinate origin o is located at the node that is earliest disturbed by the seismic waves than any other nodes on the excitation boundary of the slope if the seismic waves are not vertically incident onto the excitation boundary of the slope, and this node is called the initial motion point of the slope seismic motion, otherwise, the coordinate origin o will be put at the node on the left corner of the excitation boundary opposite to the slope surface; and calculating stress components of incident waves of different seismic phases according to the incident angles and the azimuth angles of the incident waves; where the different seismic phases include P wave, SV wave and SH wave; and specifically, the particle vibration displacement caused by the P wave will cause a compressing or stretching action on the medium in front of the wave propagation along the direction of wave propagation. The P-wave displacement initial motion can be divided into two types respectively having a same direction as wave propagation and a direction opposite to wave propagation: the P-wave displacement initial motion having the same direction as wave propagation pushes forward to exert a pressure on the medium in front of it, and thus is referred to as a compression wave is recorded as P⁺; and the P-wave displacement initial motion having the direction opposite to wave propagation pushes backward to exert a pulling force on the medium in front of it, and thus is referred to as a stretching wave and recorded as P⁻.

The particle vibration displacement caused by the SV wave is perpendicular to the wave propagation direction in the incident plane (a vertical plane that is decided by the wave ray and the vertical line across the incident node) and causes a shearing action on the medium in front of it. Looking forward along the wave propagation direction in the incident plane, the SV-wave displacement initial motion can be divided into two types respectively towards right and left: the SV-wave displacement initial motion towards right can be referred to as a right shear SV wave for short, which is recorded as SV⁺; and the SV-wave displacement initial motion towards left can be referred to as a left shear SV wave for short, which is recorded as SV⁻.

The particle vibration displacement caused by the SH wave is perpendicular to the incident plane and the wave propagation direction, and also causes a shearing action on the medium in front of it, the particle vibration direction constantly being horizontal. Looking forward along the wave propagation direction, the SH-wave displacement initial motion can be divided into two types respectively moving horizontally to right and to left: the SH-wave displacement initial motion moving horizontally to right can be referred to as a right shear SH wave for short, which is recorded as SH⁺; and the SH-wave displacement initial motion moving horizontally to left is referred to as a left SH wave for short, which is recorded as SH⁻.

The start timing of the seismic disturbances at respective nodes on the excitation boundary at the bottom of the slope is calculated according to the incident angles of the incident waves, the azimuth angles of the incident waves and the propagation speeds of the incident waves; and the seismic dynamic action time histories at respective nodes on the excitation boundary at the bottom of the numerical model of the slope is acquired according to the stress components of incident waves of different seismic phases and the start timing of the seismic disturbances at respective nodes on the excitation boundary at the bottom of the slope.

Optionally, the step of calculating stress components of incident waves of different seismic phases according to the incident angles of the incident waves and the azimuth angles of the incident waves specifically includes: calculating displacement components of incident waves of different seismic phases according to the incident angles of incident waves and the azimuth angles of the incident waves; and calculating stress components of incident waves of different seismic phases according to the displacement components of the incident waves of different seismic phases.

The process includes: establishing a local coordinate system (x, y, z) for the numerical model of the slope, where the x and y axes are located in the horizontal plane where the excitation boundary at the bottom of the slope is located, and the x or y axis is along a direction with the maximum gradient of the slope, the z axis is vertically upward, the three axes of x, y and z are orthogonal to each other to form a right-hand rectangular coordinate system, the coordinate origin o is located at the node that is earliest disturbed by the seismic waves than any other nodes on the excitation boundary of the slope if the seismic waves are not vertically incident onto the excitation boundary of the slope, and this node is called the initial motion point of the slope seismic motion, otherwise, the coordinate origin o will be put at the node on the left corner of the excitation boundary opposite to the slope surface; and determining displacement components of different types of incident waves according to incident angles and azimuth angles of seismic waves; where the incident angle of the seismic wave is the included angle θ between the incident wave ray and the normal line of the excitation plane, the azimuth angle of the incident seismic wave is the angle α between the horizontal projection direction of the incident wave ray and the direction of the x axis, and the different types of incident waves include three kinds of waves, i.e., P wave, SV wave, and SH wave.

### Displacement Component of P Wave

Assuming that the displacement vectors of the compression wave P⁺ (the displacement initial motion moves forward along the ray direction) and the stretching wave P⁻ (the displacement initial motion moves backward along the ray direction) are equal in magnitude and opposite in direction, then the relationship between the displacement vector module S_{P}⁺ of P⁺ and the displacement vector module S_{P}⁻ of P⁻ is as follows:

S_{P}⁺=−S_{P}⁻=S_{P}

Accordingly, the relationships between the displacement components u_{P}, v_{P} and w_{P} of the longitudinal wave P (compression wave P⁺ and stretching wave P⁻) and the displacement vector module S_{P} are respectively as shown in equation (17) and equation (18): Displacement component of the compressive wave P⁺:

u_{P}=S_{P}·sin θ·cos α

v_{P}=S_{P}·sin θ·sin α

w_{P}=S_{P}·cos θ (17)

Displacement component of the stretching wave P⁻:

u_{P}=−S_{P}·sin·cos α

v_{P}=−S_{P}·sin θ·sin α

w_{P}=−S_{P}·cos θ (18)

where, S_{P} represents the module of the P wave displacement vector time history with the initial motion moving forward or backward. For a single-frequency simple-harmonic wave: S_{P}=A_{P}· [symbol] , and for any non-simple-harmonic wave:

$${S}_{P} = {\sum }_{j} {A}_{Pj} \cdot {e}^{i ( {\vec{k}}_{Pj} \cdot \vec{r} - {ω}_{j} t )} ,$$

where A_{P}=A_{P}(x, y, z) and A_{Pj}=A_{Pj}(x, y, z) are amplitudes of the simple harmonic wave and can be regarded as a constant within a certain range near the point (x, y, z); [symbol] and [symbol] are wave vectors of the P wave, and the wave number

$${k}_{P} = \vert {\vec{k}}_{P} \vert = \frac{ω}{c} , {k}_{Pj} = \vert {\vec{k}}_{Pj} \vert = \frac{{ω}_{j}}{{c}_{P}} ,$$

in which c_{P} is the wave velocity of the longitudinal wave.

### Displacement Component of SV Wave

Assuming that the displacement vectors of the right shear SV wave SV⁺ (the displacement initial motion is perpendicular to the ray direction and moves towards right) and the left shear SV wave SV⁻ (the displacement initial motion is perpendicular to the ray direction and moves towards left) are equal in magnitude and opposite in direction, then the relationship between the displacement vector module S_{V}⁺ of the SV⁺ wave and the displacement vector module S_{V}⁻ of the SV⁻ wave is as follows:

S_{V}⁺=−S_{V}⁻=S_{V}

Accordingly, the relationships between the displacement components u_{V}, v_{V} and w_{V} of the SV waves (SV⁺ and SV⁻) and the displacement vector module S_{V} are respectively as shown in the equation (19) and equation (20). The displacement component of the right shear wave SV⁺ is:

u_{V}=S_{V}·cos θ·cos α

v_{V}=S_{V}·cos θ·sin α

w_{V}=−S_{V}·sin θ (19)

The displacement component of the left shear wave SV⁻ is:

u_{V}=−S_{V}·cos θ·cos α

v_{V}=−S_{V}·cos θ·sin α

w_{V}=S_{V}·sin θ (20)

where, S_{V} represents the module of the displacement vector time history of the right shear or left shear SV wave. for a single-frequency simple-harmonic wave: S_{V}=A_{V}· [symbol] , and for any non-simple-harmonic wave:

$${S}_{V} = {\sum }_{j} {A}_{Vj} \cdot {e}^{i ( {\vec{k}}_{Sj} \cdot \vec{r} - {ω}_{j} t )} ,$$

where, A_{V}=A_{V}(x,y,z) and A_{Vj}=A_{Vj}(x,y,z) are amplitudes of the simple harmonic wave and can be regarded as a constant within a certain range near the point (x,y,z); [symbol] and [symbol] are wave vectors of the S wave, and the wave number

$${k}_{S} = \vert {\vec{k}}_{S} \vert = \frac{ω}{{c}_{S}} , {k}_{Sj} = \vert {\vec{k}}_{Sj} \vert = \frac{{ω}_{j}}{{c}_{S}} ,$$

in which c_{S} is the wave velocity of the S wave.

### Displacement Component of SH Wave

Assuming that the displacement vectors of the right shear SH wave SH⁺ (the displacement initial motion is perpendicular to the ray direction and moves towards right) and the left shear SH wave SH⁻ (the displacement initial motion is perpendicular to the ray direction and moves towards left) are equal in magnitude and opposite in direction, then the relationship between the displacement vector module S_{H}⁺ of the SH⁺ wave and the displacement vector module S_{H}⁺ of the SH⁻ wave is as follows:

S_{H}⁺=−S_{H}⁻=S_{H}

Accordingly, the relationships between the displacement components u_{H}, v_{H} and w_{H}≡0 of the SH waves (SH⁺ and SH⁻) and the displacement vector module S_{H} are respectively as shown in the equation (21) and equation (22). The displacement component of the right shear wave SH⁺ is:

u_{H}=S_{H}·sin α

v_{H}=−S_{H}·cos α□

w_{H}≡0 (21)

The displacement component of the left shear wave SH⁻ is:

u_{H}=−S_{H}·sin α

v_{H}=S_{H}·cos α□

w_{H}≡0 (22)

where, S_{H} represents the module of the displacement vector time history with the initial motion of the right shear or left shear SH wave. For a single-frequency simple-harmonic wave: S_{H}=A_{H}· [symbol] , and for any non-simple-harmonic wave:

$${S}_{H} = {\sum }_{j} {A}_{Hj} \cdot {e}^{i ( {\vec{k}}_{Sj} \cdot \vec{r} - {ω}_{j} t )} ;$$

where A_{H}=A_{H}(x, y, z) and A_{Hj}=A_{Hj}(x, y, z) are amplitudes of the simple harmonic wave and can be regarded as a constant within a certain range near the point (x, y, z); [symbol] and [symbol] are wave vectors of the S wave, and the wave number

$${k}_{S} = \vert {\vec{k}}_{S} \vert = \frac{ω}{{c}_{S}} , {k}_{Sj} = \vert {\vec{k}}_{Sj} \vert = \frac{{ω}_{j}}{{c}_{S}} ,$$

in which c_{S} is the wave velocity of the S wave.

Stress components of different kinds of incident waves are calculated according to the displacement components of the different kinds of incident waves; and in the local coordinate system of the slope, there are three wave stress components on the excitation boundary at the bottom of the slope: σ_{z}, τ_{zx} and τ_{zy}. According to the geometrical equation (strain-displacement relationship) and the physical equation (stress-strain relationship) in elastic mechanics, the relationship between the wave stress components τ_{z}, τ_{zx} and r_{zy} and the wave displacement (particle displacement) components u, v and w can be obtained, as shown in the equation (23):

$$\{ \begin{matrix}{σ}_{z} = λ ( \frac{\partial u}{\partial x} + \frac{\partial v}{\partial y} ) + ( λ + 2 μ ) \frac{\partial w}{\partial z} \\ {τ}_{zx} = μ ( \frac{\partial u}{\partial z} + \frac{\partial w}{\partial x} ) \\ {τ}_{zy} = μ ( \frac{\partial v}{\partial z} + \frac{\partial w}{\partial y} )\end{matrix} \qquad ( 23 )$$

By substituting the displacement formulas of body wave seismic phases P (P⁺, P⁻), SV (SV⁺, SV⁻), SH (SH⁺, SH⁻) shown in the equations (17) to (22) into equation (23) respectively, the expression of the relationship between the wave stress components τ_{z}, τ_{zx} and τ_{zy} and the wave displacement velocity (particle vibration velocity) can be obtained as follows:

### (1) Stress Component of P Wave

Stress component of compression wave P⁺

$$\{ \begin{matrix}{σ}_{{zP}^{+}} = - ( λ + 2 μ \cdot {cos}^{2} θ ) \cdot \frac{{V}_{P}}{{c}_{P}} \\ {τ}_{{zxP}^{+}} = - μ \cdot sin 2 θ \cdot cos α \cdot \frac{{V}_{P}}{{c}_{P}} \\ {τ}_{{zyP}^{+}} = - μ \cdot sin 2 θ \cdot cos α \cdot \frac{{V}_{P}}{{c}_{P}}\end{matrix} \qquad ( 24 )$$

Stress component of stretching wave P⁻

$$\{ \begin{matrix}{σ}_{{zP}^{-}} = ( λ + 2 μ \cdot {cos}^{2} θ ) \cdot \frac{{V}_{P}}{{c}_{P}} \\ {τ}_{{zxP}^{-}} = μ \cdot sin 2 θ \cdot cos α \cdot \frac{{V}_{P}}{{c}_{P}} \\ {τ}_{{zyP}^{-}} = μ \cdot sin 2 θ \cdot cos α \cdot \frac{{V}_{P}}{{c}_{P}}\end{matrix} \qquad ( 25 )$$

### (2) Stress Component of SV Wave

Stress Component of Right Shear Wave SV⁺

$$\{ \begin{matrix}{σ}_{{zV}^{+}} = μ \cdot sin 2 θ \cdot \frac{{V}_{V}}{{c}_{S}} \\ {τ}_{{zxV}^{+}} = - μ \cdot cos 2 θ \cdot cos α \cdot \frac{{V}_{V}}{{c}_{S}} \\ {τ}_{{zyV}^{+}} = - μ \cdot cos 2 θ \cdot sin α \cdot \frac{{V}_{V}}{{c}_{S}}\end{matrix} \qquad ( 26 )$$

Stress Component of Left Shear Wave SV⁻

$$\{ \begin{matrix}{σ}_{{zV}^{-}} = - μ \cdot sin 2 θ \cdot \frac{{V}_{V}}{{c}_{S}} \\ {τ}_{{zxV}^{-}} = μ \cdot cos 2 θ \cdot cos α \cdot \frac{{V}_{V}}{{c}_{S}} \\ {τ}_{{zyV}^{-}} = μ \cdot cos 2 θ \cdot sin α \cdot \frac{{V}_{V}}{{c}_{S}}\end{matrix} \qquad ( 27 )$$

### (3) Stress Component of SH Wave

Stress Component of Right Shear Wave SH⁺

$$\{ \begin{matrix}{σ}_{{zH}^{+}} = 0 \\ {τ}_{{zxH}^{+}} = - μ \cdot cos θ \cdot sin α \cdot \frac{{V}_{H}}{{c}_{S}} \\ {τ}_{{zyH}^{+}} = μ \cdot cos θ \cdot cos α \cdot \frac{{V}_{H}}{{c}_{S}}\end{matrix} \qquad ( 28 )$$

Stress Component of Left Shear Wave SH⁻

$$\{ \begin{matrix}{σ}_{{zH}^{-}} = 0 \\ {τ}_{{zxH}^{-}} = μ \cdot cos θ \cdot sin α \cdot \frac{{V}_{H}}{{c}_{S}} \\ {τ}_{{zyH}^{-}} = - μ \cdot cos θ \cdot cos α \cdot \frac{{V}_{H}}{{c}_{S}}\end{matrix} \qquad ( 29 )$$

In equations (24) to (29), V_{P}, V_{V} and V_{H} are respectively modules of the particle vibration velocity time histories generated by propagation of the P (P⁺, P⁻) wave, SV (SV⁺, SV⁻) wave and SH (SH⁺, SH⁻) wave in a medium (modules of vibration velocity dynamic vectors), and are the first derivatives of corresponding particle displacement time history modules with respect to time t. V_{P}, V_{V} and V_{H} not only can represent the particle vibration velocity time history modules of simple harmonic waves, but also can represent the particle vibration velocity time history modules of non-simple harmonic waves. For a simple harmonic wave, by taking a first derivative of a particle vibration displacement time history module S (S_{P}, S_{V}, S_{H}) with respect to the time t, the particle vibration velocity time history module V (V_{P}, V_{V}, V_{H}) can be obtained as:

$$V = \frac{\partial S}{\partial t} = {V}_{m} \cdot {e}^{i ( \vec{k} \cdot \vec{r} - ω t + \frac{π}{2} )} ,$$

where Vₘ=−ω·A is the amplitude of at the particle vibration velocity (the maximum value of vibration velocity), where ω is a circular frequency of particle vibration, and A is the displacement amplitude of particle vibration (the maximum value of displacement). For the P wave, V=V_{P}, Vₘ=V_{Pm}=−ω·A_{P}, and [symbol] = [symbol] ; for the SV wave, V=V_{V}, Vₘ=V_{Vm}=ω·A_{V}, and [symbol] = [symbol] ; and for the SH wave, V=V_{H}, Vₘ=V_{Hm}=ω·A_{H}, and [symbol] = [symbol] . For a non-simple harmonic wave, by taking a first derivative of a particle vibration displacement time history module S (S_{P}, S_{V}, S_{H}) with respect to the time t, the particle vibration velocity time history module V (V_{P}, V_{V}, V_{H}) can be obtained as:

$$V = \frac{\partial S}{\partial t} = {\sum }_{j} {V}_{mj} \cdot {e}^{i ( {\overline{k}}_{j} \cdot \overline{r} - {ω}_{j} t + \frac{π}{2} )} ,$$

where Vₘⱼ=−ωⱼ·Aⱼ is the amplitude of the particle vibration velocity of the j-th simple harmonic wave component (the maximum value of vibration velocity), where ωⱼ is a circular frequency of particle vibration of the j-th simple harmonic wave component, and Aⱼ is the displacement amplitude of particle vibration of the j-th simple harmonic wave component (the maximum value of displacement). For the P wave, V=V_{P}, Vₘⱼ=V_{Pmj}=−ωⱼ·A_{Pj}, and [symbol] = [symbol] ; for the SV wave, V=V_{V}, Vₘⱼ=V_{Vmj}=−ωⱼ·A_{Vj}, and [symbol] = [symbol] ; and for the SH wave, V=V_{H}, Vₘⱼ=V_{Hmj}=−ωⱼ·A_{Hj}, and [symbol] = [symbol] .

Specifically, the purpose of searching for the critical seismic acceleration of the slope is to determine the resistance of the slope to a given seismic action manner, and the resistance of the slope to this seismic action manner is expressed by the critical seismic acceleration of this seismic action manner.

Optionally, the step of calculating the start timing of the seismic disturbances at respective nodes on the excitation boundary at the bottom of the slope according to the incident angle of the incident wave, the azimuth angle of the incident wave and the propagation speed of the incident wave specifically includes: calculating the propagation distance of the front edge of the seismic wave by using the equation (1):

rᵢⱼ=lᵢⱼ·sin θ

lᵢⱼ=i·Δx·cos α+j·Δy·sin α (1)

where, rᵢⱼ is the distance that the wavefront of the incident seismic wave passes through from the initial motion point on the excitation boundary at the bottom of the slope to the node (i,j) in the wave propagation direction, lᵢⱼ is the apparent distance on the excitation boundary at the bottom of the slope corresponding to the seismic wave propagation distance rᵢⱼ, i.e., the distance from the initial motion point to the node (i,j) on the excitation surface, Δx is the grid-edge length in the x-axis direction, Δy is the grid-edge length in the y-axis direction, α is the azimuth angle of the seismic wave, and θ is the incident angle of the seismic wave; calculating the time points at which the seismic wave reaches respective nodes by using equation (2) according to the propagation distance of the wavefront of the seismic wave;

$${t}_{ij} = {t}_{0} + \frac{{r}_{ij}}{c} = {t}_{0} + \frac{i \cdot Δ x \cdot cos α + j \cdot Δ y \cdot sin α}{c} \cdot sin θ \qquad ( 2 )$$

where, tᵢⱼ is the time point at which the seismic wave of the seismic phase reaches the node (i,j) on the excitation boundary at the bottom of the slope; t₀ is time point at which the seismic wave of the seismic phase reaches the initial motion point on the excitation boundary at the bottom of the slope and is determined according to the distance from the potential hypocenter position to the slope site and the propagation speed of the seismic wave of the seismic phase in a regional crust; and c is an elastic wave velocity of a medium below the excitation boundary of the slope, which is expressed as c_{P} when the wave is a longitudinal wave, and is expressed as c_{S} when the wave is a transverse wave; and where the time points at which the seismic waves of different seismic phases reach respective nodes on the excitation boundary at the bottom of the slope, as calculated by equation (2), are the start timing of the seismic disturbances of different seismic phases at respective nodes on the excitation boundary at the bottom of the slope.

Optionally, the step of acquiring the seismic dynamic action time histories at respective nodes on the excitation boundary at the bottom of the numerical model of the slope according to the stress components of the incident waves of different seismic phases and the start timing of the seismic disturbances at respective nodes on the excitation boundary at the bottom of the slope specifically includes: superposing the stress component time histories generated by seismic waves of different seismic phase successively arriving at respective nodes according to the start timing of the seismic wave disturbances of different seismic phases at respective nodes on the excitation boundary at the bottom of the slope, namely, taking the algebraic sum of the same stress components corresponding to different seismic phases at respective time points in the duration of the seismic disturbance at each excitation node, to obtain the seismic dynamic action time history of each node on the excitation boundary at the bottom of the slope.

According to the stress components of various seismic waves and the start timing of the seismic disturbances at respective nodes on the excitation boundary at the bottom of the slope, the input wave stress time histories of respective nodes on the excitation boundary at the bottom of the slope are calculated.

(1) Stress Component Time History of P Wave (t≤t_{Pij})

Stress Component Time History of Compression Wave P⁺

$$\{ \begin{matrix}{σ}_{{zP}^{+}} ( t - {t}_{Pij} ) = - ( λ + 2 μ \cdot {cos}^{2} θ ) \cdot \frac{{V}_{P} ( t - {t}_{Pij} )}{{c}_{P}} \\ {τ}_{{zxP}^{+}} ( t - {t}_{Pij} ) = - μ \cdot sin 2 θ \cdot cos α \cdot \frac{{V}_{P} ( t - {t}_{Pij} )}{{c}_{P}} \\ {τ}_{{zyP}^{+}} ( t - {t}_{Pij} ) = - μ \cdot sin 2 θ \cdot cos α \cdot \frac{{V}_{P} ( t - {t}_{Pij} )}{{c}_{P}}\end{matrix} \qquad ( 30 )$$

Stress Component Time History of Stretching Wave P⁻

$$\{ \begin{matrix}{σ}_{{zP}^{-}} ( t - {t}_{Pij} ) = ( λ + 2 μ \cdot {cos}^{2} θ ) \cdot \frac{{V}_{P} ( t - {t}_{Pij} )}{{c}_{P}} \\ {τ}_{{zxP}^{-}} ( t - {t}_{Pij} ) = μ \cdot sin 2 θ \cdot cos α \cdot \frac{{V}_{P} ( t - {t}_{Pij} )}{{c}_{P}} \\ {τ}_{{zyP}^{-}} ( t - {t}_{Pij} ) = μ \cdot sin 2 θ \cdot cos α \cdot \frac{{V}_{P} ( t - {t}_{Pij} )}{{c}_{P}}\end{matrix} \qquad ( 31 )$$

(2) Stress Component Time History of SV Wave (t≤t_{Sij})

Stress Component Time history of Right Shear Wave SV⁺

$$\{ \begin{matrix}{σ}_{{zV}^{+}} ( t - {t}_{Sij} ) = μ \cdot sin 2 θ \cdot \frac{{V}_{V} ( t - {t}_{Sij} )}{{c}_{S}} \\ {τ}_{{zxV}^{+}} ( t - {t}_{Sij} ) = - μ \cdot cos 2 θ \cdot cos α \cdot \frac{{V}_{V} ( t - {t}_{Sij} )}{{c}_{S}} \\ {τ}_{{zyV}^{+}} ( t - {t}_{Sij} ) = - μ \cdot cos 2 θ \cdot sin α \cdot \frac{{V}_{V} ( t - {t}_{Sij} )}{{c}_{S}}\end{matrix} \qquad ( 32 )$$

Stress Component Time history of Left Shear Wave SV⁻

$$\{ \begin{matrix}{σ}_{{zV}^{-}} ( t - {t}_{Sij} ) = - μ \cdot sin 2 θ \cdot \frac{{V}_{V} ( t - {t}_{Sij} )}{{c}_{S}} \\ {τ}_{{zxV}^{-}} ( t - {t}_{Sij} ) = μ \cdot cos 2 θ \cdot cos α \cdot \frac{{V}_{V} ( t - {t}_{Sij} )}{{c}_{S}} \\ {τ}_{{zyV}^{-}} ( t - {t}_{Sij} ) = μ \cdot cos 2 θ \cdot sin α \cdot \frac{{V}_{V} ( t - {t}_{Sij} )}{{c}_{S}}\end{matrix} \qquad ( 33 )$$

(3) Stress Component Time History of SH Wave (t≤t_{Sij})

Stress Component Time history of Right Shear Wave SH⁺

$$\{ \begin{matrix}{σ}_{{zH}^{+}} ( t - {t}_{Sij} ) = 0 \\ {τ}_{{zxH}^{+}} ( t - {t}_{Sij} ) = - μ \cdot cos θ \cdot sin α \cdot \frac{{V}_{H} ( t - {t}_{Sij} )}{{c}_{S}} \\ {τ}_{{zyH}^{+}} ( t - {t}_{Sij} ) = μ \cdot cos θ \cdot cos α \cdot \frac{{V}_{H} ( t - {t}_{Sij} )}{{c}_{S}}\end{matrix} \qquad ( 34 )$$

Stress Component Time history of Left Shear Wave SH⁻

$$\{ \begin{matrix}{σ}_{{zH}^{-}} ( t - {t}_{Sij} ) = 0 \\ {τ}_{{zxH}^{-}} ( t - {t}_{Sij} ) = μ \cdot cos θ \cdot sin α \cdot \frac{{V}_{H} ( t - {t}_{Sij} )}{{c}_{S}} \\ {τ}_{{zyH}^{-}} ( t - {t}_{Sij} ) = - μ \cdot cos θ \cdot cos α \cdot \frac{{V}_{H} ( t - {t}_{Sij} )}{{c}_{S}}\end{matrix} \qquad ( 35 )$$

The combined wave stress time histories of different seismic phases at the nodes on the excitation boundary at the bottom of the slope are superimposed to obtain the seismic dynamic action time history for incidence on the slope site at arbitrary incidence angles from different azimuths. According to the relationship between the wave displacement direction and the wave ray, there are three types of body wave seismic phases P, SV and SH that reach the excitation boundary, and further considering the displacement direction of initial motion of the wave, they can be further divided into six categories of P⁺, P⁻; SV⁺, SV⁻; SH⁺, SH⁻, i.e., P (P⁺, P⁻) waves, SV (SV⁺, SV⁻) waves, and SH (SH⁺, SH⁻) waves. Considering the physical reality of wave propagation, the possible combinations of wave seismic phases at any node on the excitation boundary include a combination of two seismic phases and a combination of three seismic phases.

### (1) Combination of Two Seismic Phases (12 Kinds)

P⁺+SV⁺,P⁺+SV⁻;P⁻+SV⁺,P⁻+SV⁻;

P⁺+SH⁺,P⁺+SH⁻;P⁻+SH⁺,P⁻+SH⁻;

SV⁺+SH⁺,SV⁺+SH⁻;SV⁻+SH⁺,SV⁻+SH⁻.

### (2) Combination of Three Seismic Phases (8 Kinds)

P⁺+SV⁺+SH⁺,P⁺+SV⁺+SH⁻;P⁺+SV⁻+SH⁺,P⁺+SV⁻+SH⁻;

P⁻+SV⁺+SH⁺,P⁻+SV⁺+SH⁻;P⁻+SV⁻+SH⁺,P⁻+SV⁻+SH⁻.

The time-history of the input wave stress at an excitation node can be obtained by considering the above possible combinations of seismic phases to select a corresponding stress component time history equation, and then taking the algebraic sum of corresponding components of waves of different seismic phases at the same time point during the whole duration of seismic disturbance at the same excitation point. For example, the input wave stress components σ_{zP}⁺_{+V}⁺(pᵢⱼ), τ_{zxP}⁺_{+V}⁺(pᵢⱼ) and τ_{zy P}⁺_{+V}⁺(pᵢⱼ) of the combination of two seismic phases P⁺+SV⁺ on the node pᵢⱼ are algebraic sums of corresponding stress component time histories according to equations (30) and (31):

$$\{ \begin{matrix}{σ}_{{zP}^{+} + {V}^{+}} ( {p}_{ij} ) = {σ}_{{zP}^{+}} ( t - {t}_{{P}_{ij}} ) + {σ}_{{zV}^{+}} ( t - {t}_{Sij} ) \\ {τ}_{{zxP}^{+} + {V}^{+}} ( {p}_{ij} ) = {τ}_{{zxP}^{+}} ( t - {t}_{{P}_{ij}} ) + {τ}_{{zxV}^{+}} ( t - {t}_{Sij} ) \\ {τ}_{{zyP}^{+} + {V}^{+}} ( {p}_{ij} ) = {τ}_{{zyP}^{+}} ( t - {t}_{{P}_{ij}} ) + {τ}_{{zyV}^{+}} ( t - {t}_{Sij} )\end{matrix} \qquad ( 36 )$$

In the present invention, based on the concept of seismic dynamic overloading stability of the slope, a dynamic load increasing method with the search for a critical seismic peak acceleration of slope failure and destabilization as the core is used to analyze the anti-seismic capacity of the slope, and a dynamic time history method is used to apply seismic loads from weak to strong, to search for the critical seismic acceleration of slope seismic destabilization which represents the anti-seismic capacity of the slope.

In particular, the method for acquiring the critical seismic acceleration of the slope specifically includes: The influence of the earthquake on the site can be expressed by the seismic acceleration, and what is obtained by monitoring the seismic motion with a strong-motion instrument is also a site seismic acceleration time history a(t). Similarly, the seismic action that the slope suffers can also be expressed by the site seismic acceleration time history a(t). Therefore, the anti-seismic capacity of the slope can be equivalent to how strong the site seismic acceleration the slope can withstand and may be expressed by the critical seismic peak acceleration a_{cp} of the slope failure and destabilization caused by an earthquake. a_{cp} is the maximum amplitude of the critical seismic action time history a_{c}(t) of the slope failure and destabilization caused by an earthquake. The so-called critical seismic action on the slope herein is the seismic action with the smallest intensity among the seismic actions which cause the slope failure and destabilization caused by an earthquake. Referring to the analysis result of the probability of the slope-site seismic acceleration, the anti-seismic capacity of the slope can be expressed using the horizontal peak seismic acceleration of the site.

The analysis process of the load increasing method is as follows: (1) Firstly, a scheme for scanning an incident seismic wave (including an azimuth angle α and an incident angle θ of the seismic wave, as well as a combination of incident seismic waves of different seismic phases at a node on the excitation boundary at the bottom of the slope and the start timing of waves of respective seismic phases) is established to determine the slope-site seismic acceleration time history a(t) of a corresponding seismic action manner; (2) At the same time, a pseudo-static method is used to calculate the initial value of the critical seismic peak acceleration a_{cp} for the slope seismic stability, such that based on the principle of ensuring that the slope will not suffer from destabilization caused by dynamic failure, and then an acceleration value aₚ₀, which is smaller than the initial value of the slope critical seismic peak acceleration a_{cp} obtained by the pseudo-static method, is taken as the maximum amplitude of the site seismic acceleration time history a(t) corresponding to the determined seismic action manner; (3) the seismic acceleration time history a(t) adjusted by the pseudo-static method is applied to respective nodes on the excitation boundary at the bottom of the numerical model of the slope according to the start timing for trial calculation, and then the amplitude value of the seismic acceleration time history is further adjusted according to the response of the numerical model of the slope to ensure that the input seismic action does not cause seismic failure of the slope. The seismic acceleration time history determined by adjustment can be used as the initial input of seismic motion time history a₁(t) to search for the critical seismic acceleration of the slope; (4) the amplitude value of the initial input of seismic acceleration time history is gradually amplified according to a certain increment η·a₁(t) (with an amplitude increment coefficient of η<1, as determined by calculation accuracy), to search for the critical seismic motion time history a_{c}(t) which causes that the slope suffers from destabilization caused by dynamic failure, to determine the peak acceleration a_{cp} of the critical seismic motion time history; and (5) in order to compare with the horizontal peak seismic acceleration having a certain exceeding probability in a certain period of time in the future obtained from the site seismic hazard analysis, the horizontal component peak acceleration a_{ch0} (abbreviated as a_{c0}) of the critical seismic motion time history is determined according to the given seismic action manner.

According to the pre-established scheme for scanning an incident seismic wave, each time of search obtains a critical seismic action of a given seismic action manner (the critical seismic motion time history and the horizontal component of its peak acceleration). The aforementioned search process is repeated continuously to obtain the critical seismic actions corresponding to all of the seismic action manners predetermined in the scanning scheme, thereby revealing the constitution of the diversity of the anti-seismic capacity of the slope and laying a foundation for further evaluation of the slope seismic stability and calculation of the probability of slope failure and destabilization caused by an earthquake.

After the critical acceleration is determined, it also includes that since the uncertainty of the potential hypocenters and the uncertainty of the strength of the slope itself both affect the critical seismic acceleration of the slope, the horizontal component peak acceleration of the critical seismic motion time history of the slope is revised based on the uncertainty of the potential hypocenter positions and the uncertainty of the strength of the slope itself, specifically including:

a_{ch}=a_{c0}±Δa_{c}

where, Δa_{c} is the uncertainty of the critical seismic acceleration (horizontal component) a_{ch} of the slope, which is calculated by the following equation: where, Δa_{hθ} is the uncertainty of the critical seismic acceleration of the slope caused by the location uncertainty of the potential hypocenter positions (which can be attributed to the uncertainty of the incident angle θ of the seismic wave), and is taken as the standard deviation between a representative-value slope S₀ (the slope with the geotechnical properties, geological structures, and topographic and geomorphological parameters of the slope being representative values) and m critical seismic acceleration horizontal components a_{chθj} corresponding to m incident angles (θⱼ, j=0, 2, . . . , m−1):

$$Δ {a}_{h θ} = \sqrt{\frac{{\sum }_{j = 0}^{m - 1} {( {a}_{ch θ j} - {a}_{h θ} )}^{2}}{m - 1}} ,$$

where a_{chθj} represents the horizontal component of the critical peak acceleration corresponding to the j-th incident angle on the azimuth α_{q}, a_{hθ} represents the average value of all m horizontal components of the critical seismic peak acceleration of slopes corresponding to all m incident angles on the azimuth α_{q}; and Δa_{hS} is the uncertainty of the critical seismic acceleration (horizontal component) of the slope caused by the uncertainty of the conditions of the slope itself.

The method for determining the uncertainty Δa_{hS} of the critical seismic acceleration (horizontal component) of the slope caused by the uncertainty of the conditions of the slope itself is as follows: considering the problem of the seismic resistance of the slope, the uncertainty of a given slope is mainly derived from the potential hypocenter positions, while the conditions of the slope itself are relatively stable and clear. As compared with the potential hypocenter positions, the conditions of the slope itself are easier to understand and can be verified through detailed investigation of the slope, such that the uncertainty of the conditions of the slope itself is obviously much less than that of the potential hypocenter positions. The conditions of the slope itself (or referred to as conditions at which landslides caused by an earthquake are easy to occur) mainly include the rock-soil mass properties, geological structures, and topographical features of the slope. For a given slope, the uncertainty of the conditions of the slope itself is mainly derived from the detail level of the investigation work and embodies specifically in the deviation of rock-soil mass property parameters, the deviation of the development conditions of the geological structures, and the deviation of the topographies of the slope. By studying the influence of the deviation of the conditions of the slope itself on the critical seismic acceleration of the slope, the knowledge that the uncertainty of the conditions of the slope itself causes the deviation of the evaluation of the anti-seismic capacity of the slope can be obtained.

Assuming that P_{R} represents the rock-soil mass properties of the slope, and the rock-soil mass property parameters that affect the seismic dynamic response and dynamic failure of the slope mainly include medium density ρ, elastic modulus E, Poison's ratio ν and damping ratio D, as well as the intensity parameters of the rock-soil mass-a cohesive force c and an internal friction angle φ, then:

P_{R}=P_{R}(ρ,E,ν,D,c,φ) (37)

Assuming that G_{S} represents the geological structure of the slope, and the main factors thereof include the thickness H, attitude A_{R} of geological layers, and the scale L, developed body density J, number of groups N, as well as attitude A_{J} of structural-planes and the like in the slope body, then:

G_{S}=G_{S}(H,A_{R},L,J,N,A_{J}) (38)

Assuming that T_{S} represents the topographical features of the slope, and the parameters that characterize the topographical features of the slope mainly include slope height h, slope angle β, slope-surface shape s and the like, then:

T_{S}=T_{S}(h,β,s) (39)

The influence of the rock-soil mass properties P_{R}, geological structures G_{S} and topographical features T_{S} of the slope on the critical seismic acceleration a_{cS} of the slope can be expressed as the function shown in the equation (40):

a_{cS}=a_{cS}(P_{R},G_{S},T_{S}) (40)

Since the deviation ΔP_{R} of rock-soil mass property parameters, the deviation ΔG_{S} of the development conditions of the geological structures, and the deviation ΔT_{S} of the topographies of the slope are of small quantities relative to the parameters (P_{R}, G_{S}, T_{S}) themselves, the influence Δa_{cS} of the deviation of the conditions of the slope itself on the critical seismic acceleration of the slope can be expressed as follows:

$$Δ {a}_{cS} = \frac{\partial {a}_{cS}}{\partial {P}_{R}} \cdot Δ {P}_{R} + \frac{\partial {a}_{cS}}{\partial {G}_{S}} \cdot Δ {G}_{S} + \frac{\partial {a}_{cS}}{\partial {T}_{S}} Δ {T}_{S} \qquad ( 41 )$$

where, partial derivatives

$$\frac{\partial {a}_{cS}}{\partial {P}_{R}} , \frac{\partial {a}_{cS}}{\partial {G}_{S}} and \frac{\partial {a}_{cS}}{\partial {T}_{S}}$$

respectively describe the sensitivities of the critical seismic acceleration a_{cS} of the slope with respect to the rock-soil mass properties P_{R}, geological structures G_{S} and topographical features T_{S} of the slope, which reflects the sensitivity of the anti-seismic capacity of the slope to the conditions of the slope itself. The increment Δa_{cS} of the critical seismic acceleration of the slope obtained by equation (41) reflects the influence on the estimation of the anti-seismic capacity of the slope due to the uncertainty of the conditions of the slope itself, and can also be referred to as the uncertainty of the critical seismic acceleration of the slope due to the deviation of the exploration results of the conditions of the slope itself from the actual conditions.

The rock-soil mass properties P_{R} of the slope, the geological structures G_{S} of the slope, and the topographical features T_{S} of the slope express the three main aspects of the conditions of the slope itself and are three comprehensively qualitative concepts which have neither a clear dimension nor a clear quantification. Therefore, it is difficult to quantify the evaluation of the influence of the conditions of the slope itself on the anti-seismic capacity of the slope according to equation (41). In order to realize the quantitative evaluation of the influence of the uncertainty of the conditions of the slope itself on the anti-seismic capacity of the slope, the deviation ΔP_{R} of the rock-soil mass properties of the slope, the deviation ΔG_{S} of the geological structures of the slope, and the deviation ΔT_{S} of the topographical features of the slope in the equation (41) are further developed as follows:

$$\begin{matrix}Δ {P}_{R} = \frac{\partial {P}_{R}}{\partial ρ} \cdot Δ ρ + \frac{\partial {P}_{R}}{\partial E} \cdot Δ E + \frac{\partial {P}_{R}}{\partial v} \cdot Δ v + \frac{\partial {P}_{R}}{\partial D} \cdot Δ D + \frac{\partial {P}_{R}}{\partial c} \cdot Δ c + \frac{\partial {P}_{R}}{\partial φ} \cdot Δ φ & ( 42 ) \\ Δ {G}_{S} = \frac{\partial {G}_{S}}{\partial H} \cdot Δ H + \frac{\partial {G}_{S}}{\partial {A}_{R}} \cdot Δ {A}_{R} + \frac{\partial {G}_{S}}{\partial L} \cdot Δ L + \frac{\partial {G}_{S}}{\partial J} \cdot Δ J + \frac{\partial {G}_{S}}{\partial N} \cdot Δ N + \frac{\partial {G}_{S}}{\partial {A}_{J}} \cdot Δ {A}_{J} & ( 43 ) \\ Δ {T}_{S} = \frac{\partial {T}_{S}}{\partial h} \cdot Δ h + \frac{\partial {T}_{S}}{\partial β} \cdot Δ β + \frac{\partial {T}_{S}}{\partial s} \cdot Δ s & ( 44 )\end{matrix}$$

In the equations (42) to (44): Δρ, ΔE, Δν, ΔD, Δc and Δϕ are respectively the deviations of the measured values of the medium density ρ, the elastic modulus E, the Poisson's ratio ν, the damping ratio D, the cohesion force c and the internal friction angle ϕ of the slope body from the true values of them; ΔH, ΔA_{R}, ΔL, ΔJ, ΔN and ΔA_{J}, A_{J} are respectively the deviations of the measured values of the thickness H, the occurrence A_{R} of geological layers, the scale L, the body density J, the number of groups N and the occurrence A_{J} of of structural-planes in the slope body from the true values of them; and Δh, Δf and Δs are respectively the deviations of the measured values of the slope height h, the slope angle β and the slope shape s of the slope from the true values of them. Partial derivatives in respective equations:

$$\frac{\partial {P}_{R}}{\partial ρ} , \frac{\partial {P}_{R}}{\partial E} , \frac{\partial {P}_{R}}{\partial v} , \frac{\partial {P}_{R}}{\partial D} , \frac{\partial {P}_{R}}{\partial c} and \frac{\partial {P}_{R}}{\partial ϕ}$$

are respectively the changing rates of the rock-soil mass properties P_{R} of the slope with respect to the rock-soil mass parameters (ρ, E, ν, D, c, φ);

$$\frac{\partial {G}_{S}}{\partial H} , \frac{\partial {G}_{S}}{\partial {A}_{R}} , \frac{\partial {G}_{R}}{\partial L} , \frac{\partial {G}_{S}}{\partial J} , \frac{\partial {G}_{S}}{\partial N} and \frac{\partial {G}_{S}}{\partial {A}_{J}}$$

are respectively the changing rates of the geological structures G_{S} of the slope with respect to the geological structure parameters (H, A_{R}, L, J, N, A_{J}); and

$$\frac{\partial {T}_{S}}{\partial h} , \frac{\partial {T}_{S}}{\partial β} and \frac{\partial {T}_{S}}{\partial s}$$

are respectively the changing rates of the topographical features T_{S} of the slope with respect to the topographical feature parameters (h, β, s) of the slope.

By substituting the equations (42) to (44) into the equation (41), the influence Δa_{cS} of the uncertainty of specific parameters corresponding to three aspects (i.e., the rock-soil mass properties P_{R} of the slope, the geological structures G_{S} of the slope and the topographical features T_{S} of the slope) on the critical seismic acceleration a_{cS} of the slope can be obtained, as shown in the equation (45):

$$Δ {a}_{cS} = \frac{\partial {a}_{cS}}{\partial ρ} \cdot Δ ρ + \frac{\partial {a}_{cS}}{\partial E} \cdot Δ E + \frac{\partial {a}_{cS}}{\partial v} \cdot Δ v + \frac{\partial {a}_{cS}}{\partial D} \cdot Δ D + \frac{\partial {a}_{cS}}{\partial c} \cdot Δ c + \frac{\partial {a}_{cS}}{\partial φ} \cdot Δ φ + \frac{\partial {a}_{cS}}{\partial H} \cdot Δ H + \frac{\partial {a}_{cS}}{\partial {A}_{R}} \cdot Δ {A}_{R} + \frac{\partial {a}_{cS}}{\partial L} \cdot Δ L + \frac{\partial {a}_{cS}}{\partial J} \cdot Δ J + \frac{\partial {a}_{cS}}{\partial N} \cdot Δ N + \frac{\partial {a}_{cS}}{\partial {A}_{j}} \cdot Δ {A}_{J} + \frac{\partial {a}_{cS}}{\partial h} \cdot Δ h + \frac{\partial {a}_{cS}}{\partial β} \cdot Δ β + \frac{\partial {a}_{cS}}{\partial s} \cdot Δ s \qquad ( 45 )$$

where, the magnitudes of the deviations (Δρ, ΔE, Δν, ΔD, Δc, Δφ; ΔH, ΔA_{R}, ΔL, ΔJ, ΔN, ΔA_{J}; Δh, Δf, Δs) of respective parameters depend on the accuracy of experimental testing and investigation survey; partial derivatives

$$( \frac{\partial {a}_{cS}}{\partial ρ} , \frac{\partial {a}_{cS}}{\partial E} , \frac{\partial {a}_{cS}}{\partial v} , \frac{\partial {a}_{cS}}{\partial D} , \frac{\partial {a}_{cS}}{\partial c} , \frac{\partial {a}_{cS}}{\partial ϕ} ; \frac{\partial {a}_{cS}}{\partial H} , \frac{\partial {a}_{cS}}{\partial {A}_{R}} , \frac{\partial {a}_{cS}}{\partial L} , \frac{\partial {a}_{cS}}{\partial J} , \frac{\partial {a}_{cS}}{\partial N} , \frac{\partial {a}_{cS}}{\partial {A}_{J}} ; \frac{\partial {a}_{cS}}{\partial h} , \frac{\partial {a}_{cS}}{\partial β} , \frac{\partial {a}_{cS}}{\partial s} )$$

of the critical seismic acceleration of the slope with respect to respective parameters reflects the sensitivities of the anti-seismic capacity of the slope to changes in respective parameters, which can be determined through orthogonal experiments of the sensitivities of the critical seismic acceleration of the slope with respect to respective parameters in the conditions of the slope itself.

From the perspective of geological disasters, the conditions of the slope itself are the conditions at which the geological disasters of the slope are easy to occur, which are not only the internal causes of the geological disasters of the slope, but also the basis which constitute the resistance of the slope to disaster-inducing factors. The changing rates of the critical seismic acceleration of the slope with respect to the rock-soil mass parameters, the geological structure parameters and the topographical feature parameters, as reflected by the partial derivatives in the equation (45), indicate the levels of sensitivity of the anti-seismic capacity of the slope to the changes in the rock-soil mass parameters, the geological structure parameters and the topographical feature parameters; and from another perspective, they are also the sensitivity coefficients of the slope destabilization state caused by seismic failure with respect to respective parameters of the conditions of the slope itself, or are referred to as sensitivity. Therefore, it can be said that Δa_{cS} located at the left of the equal sign of the equation (45) is the uncertainty of the critical seismic acceleration a_{cS} of the slope caused by the uncertainty of the conditions of the slope itself. Referring to equation (45), the horizontal components a_{chS} and Δa_{hS} of a_{cS} and its uncertainty Δa_{cS} are taken according to the given manner of seismic action, and then:

a_{chS}=a_{hS}±Δa_{hS}

where, a_{hS} is the representative value of the critical seismic acceleration (horizontal component) of the slope corresponding to a given manner of seismic action, which is obtained by establishing a slope model (i.e., the representative-value slope S₀) by representative values (measured values) of the parameters of the conditions of the slope itself, and then searching by the load increasing method.

The step of determining a probability of slope failure and destabilization caused by an earthquake according to the exceeding probability curve of slope-site seismic acceleration and the slope critical seismic accelerations specifically includes: for the probability of slope failure and destabilization caused by an earthquake, as shown in FIG. 5, in the graph showing the exceeding probability curve, the critical seismic acceleration a_{c} (a_{c}=a_{c0}±Δa_{c}) of the slope is mapped onto the horizontal axis (aₛ), the representative value is used as the center a_{c0}, and the range of the horizontal axis covered by the uncertainty Δa_{c} is 2Δa_{c}. Via the exceeding probability curve, on the longitudinal axis what corresponds to a_{c} (a_{c}=a_{c0}±Δa_{c}) is the exceeding probability P_{c} (P_{c}=P_{c0}±ΔP_{c}) at which the site seismic acceleration a_{S} reaches or exceeds the critical seismic acceleration a_{c} of the slope. According to the concept of the critical seismic acceleration of the slope, the occurrence of the event aₛ≤a_{c} means that the slope suffers from failure and destabilization. That is, the exceeding probability P_{c} is just the probability of slope failure and destabilization caused by an earthquake.

After the step of determining a probability of slope failure and destabilization caused by an earthquake according to the exceeding probability curve of slope-site seismic acceleration and the slope critical seismic accelerations, it also includes calculation of the seismic stability coefficient of the slope and evaluation of the slope stability state, with the main steps of: determining a seismic acceleration of the site fortification for a certain period of time in the future according to relevant requirements of seismic fortification in a slope site area; and calculating a slope seismic stability coefficient and its uncertainty, according to the slope critical seismic acceleration and its uncertainty as well as the seismic acceleration of the site fortification.

The seismic stability of the slope is evaluated according to the seismic stability coefficient.

The details are as follows: following the concept of slope stability coefficient (the ratio of slope resistance to slope collapsing force) for evaluating the static stability of the slope, the slope seismic stability safety coefficient K_{d} is defined as: the ratio between the slope seismic resistance and the seismic action force to which the slope is subjected; and take the critical seismic acceleration a_{c} of the slope as the representative of the slope seismic resistance and take the site seismic acceleration as as the representative of the seismic action force to which the slope is subjected, the slope seismic stability coefficient K_{d} can be expressed as:

K_{d}=a_{c}/aₛ.

For evaluating the slope seismic stability in a certain period of time in the future, the site seismic action with the exceeding probability of 10% can be taken as the seismic action force to which the slope may be subjected to, such that aₛ=a₁₀, and

K_{d}=a_{c}/a₁₀.

In consideration of the uncertainty of the slope critical seismic acceleration, the slope seismic stability coefficient also has corresponding uncertainty,

K_{d}=K_{d0}±ΔK_{d};

where, K_{d0} is the representative value of the slope seismic stability coefficient K_{d}; and ΔK_{d} is the uncertainty of K_{d}.

K_{d0}=a_{c0}/a₁₀

ΔK_{d}=Δa_{c}/a₁₀

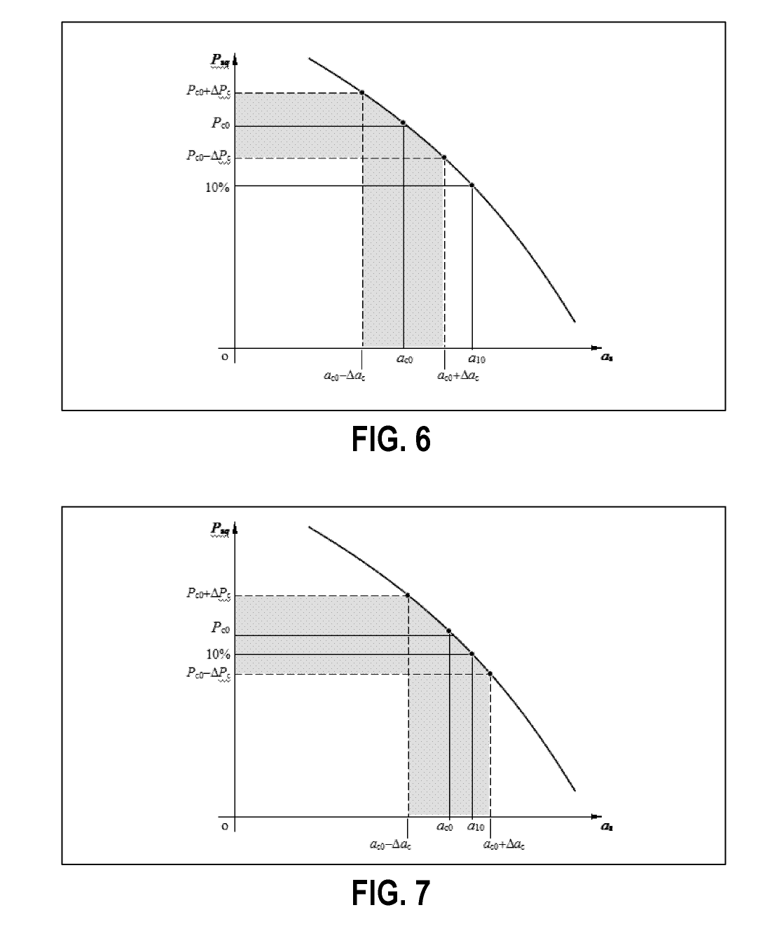

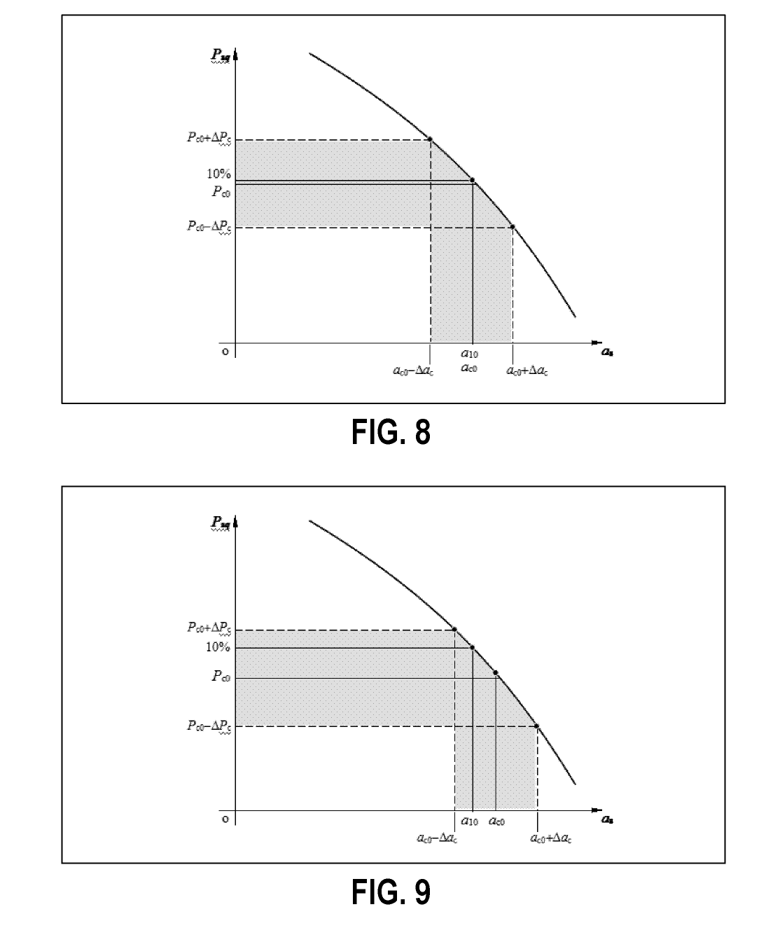

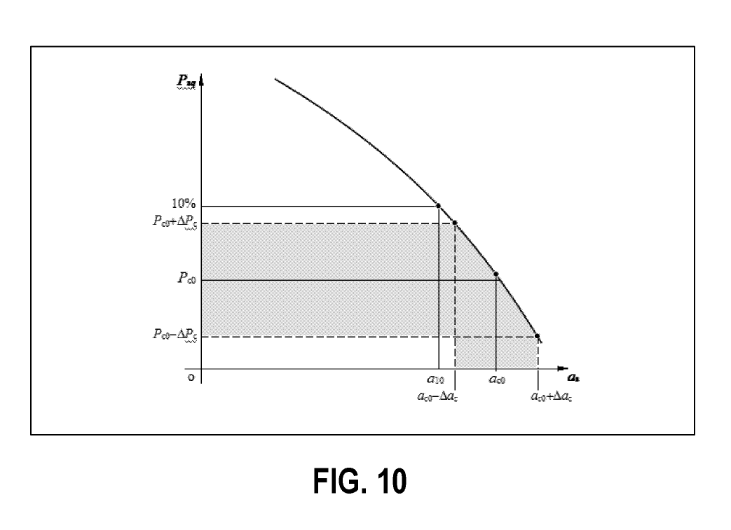

As shown in FIG. 6 to FIG. 10, when the slope seismic stability coefficient is investigated from the relationship between the slope critical seismic acceleration a_{c} and the fortification seismic acceleration a₁₀ with the exceeding probability of 10%, the slope seismic stability state can be divided into 5 cases: (1) as shown in FIG. 6, the slope critical seismic acceleration and its possible changing values (a_{c}=a_{c0}±Δa_{c}) are both smaller than the fortification seismic acceleration a₁₀, a₁₀>a_{c0}+Δa_{c}, and K_{d}<1, such that the slope seismic stability is very poor, and it is very likely that the failure and destabilization will occur; (2) as shown in FIG. 7, the slope critical seismic acceleration and its possible changing values (a_{c}=a_{c0}±Δa_{c}) include the fortification seismic acceleration a₁₀, a_{c0}<a₁₀≥a_{c0}+Δa_{c}, K_{d0}0<1, and the possibility of K_{d}>1 is less than that of K_{d}<1, such that the slope stability is poor, and the possibility of seismic destabilization is very high; (3) as shown in FIG. 8, the slope critical seismic acceleration and its possible changing values (a_{c}=a_{c0}±Δa_{c}) include the fortification seismic acceleration a₁₀, a₁₀=a_{c0}, K_{d0}=1, and the possibility of K_{d}>1 is comparable to that of K_{d}<1, such that the slope is at a critical stable state, and seismic destabilization may occur; (4) as shown in FIG. 9, the slope critical seismic acceleration and its possible changing values (a_{c}=a_{c0}±Δa_{c}) include the fortification seismic acceleration a₁₀, a_{c0-}Δa_{c}≥a₁₀<a_{c0}, K_{d0}>1, and the possibility of K_{d}>1 is greater than that of K_{d}<1, such that the slope stability is relatively good, but there is still the possibility of seismic destabilization; and (5) as shown in FIG. 10, the slope critical seismic acceleration and its possible changing values (a_{c}=a_{c0}±Δa_{c}) are both greater than the fortification seismic acceleration a₁₀, a₁₀<a_{c0-}Δa_{c}, and K_{d}>1, such that the slope seismic stability is very good, and the possibility of seismic destabilization is very small.

The possibilities of slope failure and destabilization caused by an earthquake corresponding to respective slope seismic stability states described above all can be quantitatively described by the slope destabilization probability (P_{c}=P_{c0}±ΔP_{c}) corresponding to the slope critical seismic acceleration (a_{c}=a_{c0}±Δa_{c}). The above situations are summarized in Table 2.

TABLE 2
Seismic Stability State of Slope and Coefficient
of Slope Seismic Stability

| | Relationship | | |
|---|---|---|---|
| | between α₁₀ | | Seismic Stability |
| Type | and α_{c} | Fetching Value of K_{d} | State of Slope |
| (1) | α₁₀ > α_{c0} + | K_{d} < 1 | The slope seismic |
| | Δα_{c} | | stability is very |
| | | | poor |
| (2) | α_{c0} < α₁₀ ≥ | K_{d0} < 1, and the possibility of | The slope seismic |
| | α_{c0} + Δα_{c} | K_{d} > 1 is less than that of K_{d} <1 | stability is |
| | | | relatively poor |
| (3) | α₁₀ = α_{c0} | K_{d0} = 1, and K_{d} > 1 and K_{d} < 1 | Critical State |
| | | have the same probability | |
| (4) | α_{c0} − Δα_{c} ≥ | K_{d0} > 1, and the possibility of | The slope seismic |
| | α₁₀ < α_{c0} | K_{d} > 1 is larger than that of | stability is |
| | | K_{d} < 1 | relatively good |
| (5) | α₁₀ < α_{c0} − | K_{d} > 1 | The slope seismic |
| | Δα_{c} | | stability is very |
| | | | good |

Note:
the possibilities of slope failure and destabilization caused by an earthquake corresponding to the five types of slope seismic stability states described above all can be quantitatively described by the slope destabilization probability (P_{c} = P_{c0} ± ΔP_{c}) corresponding to the slope critical seismic acceleration (α_{c} = α_{c0} ± Δα_{c}).

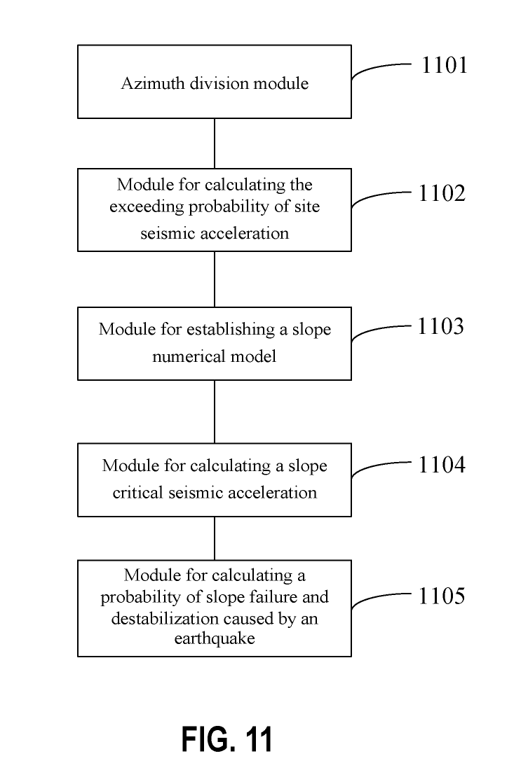

As shown in FIG. 11, the present invention further provides a system for acquiring a probability of slope failure and destabilization caused by an earthquake, including: a module 1101 for dividing azimuth domains in an area around a site at which a slope is located as a center, configured for performing azimuth division in an area around a site at which a slope is located as a center, to obtain different azimuth domains; a module 1102 for calculating the exceeding probability of site seismic acceleration, configured for pre-setting a seismic acceleration threshold value that varies within a certain range, and calculating an exceeding probability of the earthquake influence intensity of each azimuth domain corresponding to each acceleration threshold value, to establish an exceeding probability curve of slope-site seismic acceleration corresponding to each azimuth domain; a module 1103 for establishing a slope numerical model, configured for establishing a numerical model of the slope; a module 1104 for calculating a slope critical seismic acceleration, configured for acquiring slope critical seismic accelerations corresponding to different seismic action manners acting on the slope numerical model; where the seismic action manners include the intensity, frequency and duration of the seismic motion as well as the nature, directions and phase differences of the seismic action forces, and the relevant influencing factors mainly include the seismic phase of the incident wave, the incident angle of the incident wave, the azimuth angle of the incident wave, and the propagation speed of the incident wave; and a module 1105 for calculating a probability of slope failure and destabilization caused by an earthquake, configured for determining a probability of slope failure and destabilization caused by an earthquake and a slope seismic stability coefficient according to the exceeding probability curve of slope-site seismic acceleration and the slope critical seismic accelerations as well as the site seismic fortification.

The present invention discloses a method and system for acquiring the probability of slope failure and destabilization caused by an earthquake, including: first determining an exceeding probability curve of slope-site seismic acceleration corresponding to each azimuth domain around a slope; then determining a critical seismic acceleration for the slope destabilization according to actual geology and topography of the slope as well as possible seismic motion manner; and finally determining the probability of slope failure and destabilization caused by an earthquake according to the exceeding probability curve of site seismic acceleration and the critical seismic acceleration of the slope; and calculating the slope seismic stability coefficient, which comprehensively considers the uncertainty of the seismic action and the uncertainty of slope failure and destabilization, to realize estimation of the probability of slope destabilization caused by an earthquake.

The embodiments described above are only descriptions of preferred embodiments of the present invention, and do not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

What is claimed is:

1. A method for acquiring a probability of slope failure and destabilization caused by an earthquake, comprising:
performing azimuth division in an area around a site at which a slope is located as a center, to obtain different azimuth domains;
pre-setting a seismic acceleration threshold value that varies within a certain range, and calculating an exceeding probability that a seismic acceleration of the slope site generated by an earthquake in each azimuth domain is greater than or equal to the seismic acceleration threshold value, to establish an exceeding probability curve of site seismic acceleration corresponding to each azimuth domain;
establishing a numerical model of the slope;
analyzing an anti-seismic capacity of the slope to a given seismic action manner by numerical simulation with the numerical model of the slope, to obtain slope critical seismic accelerations corresponding to different azimuth domains; and
determining a probability of slope failure and destabilization caused by an earthquake according to the exceeding probability curve of site seismic acceleration and the slope critical seismic accelerations associated with an azimuth domain.

2. The method of claim 1, wherein the step of pre-setting a seismic acceleration threshold value that varies within a certain range, and calculating the exceeding probability that the seismic acceleration of the slope site generated by an earthquake in each azimuth domain is greater than or equal to the seismic acceleration threshold value, to establish an exceeding probability curve of site seismic acceleration corresponding to each azimuth domain, further comprises:
pre-setting the seismic acceleration threshold value that varies within a certain range;
acquiring magnitudes, numbers and epicenter positions of potential earthquakes probably occurring in each azimuth domain in a given period of time in the future according to data about historical and current earthquake activities in each azimuth domain; and establishing earthquake recurrence law for each azimuth domain describing the relationship between magnitudes and numbers of potential earthquakes in each azimuth domain within a certain period of time in the future;
establishing an earthquake annual occurrence rate matrix corresponding to each azimuth domain based on the earthquake recurrence law established above, wherein the matrix is set up with a frame of earthquake magnitudes (a grading of magnitude sequence) and epicentral distances (a grading of distance sequence);
establishing seismic attenuation law, describing the relationship between earthquake influence intensities and epicentral distances, for each azimuth domain from data of historical seismic intensities and current earthquake ground motion records;
establishing an earthquake influence intensity matrix of each azimuth domain based on the seismic attenuation law established above, wherein the matrix is also set up with the same frame of earthquake magnitudes and epicentral distances as that used in the earthquake annual occurrence rate matrix;
searching all elements greater than or equal to a given pre-set threshold seismic acceleration in the earthquake influence intensity matrix of each azimuth domain, and finding relative elements in the earthquake annual occurrence rate matrix of the same azimuth domain with the same magnitudes and the same distances as those elements greater than or equal to the given pre-set threshold seismic acceleration in the earthquake influence intensity matrix with, furthermore, adding up these elements of earthquake annual occurrence rates to obtain an exceeding rate of earthquake influence intensity to the given threshold seismic acceleration;
making the seismic acceleration threshold value vary within a value domain thereof, to obtain the exceeding rate curve of earthquake influence intensity for a site corresponding to the azimuth domain; and
according to a concept of safety and risk of a disaster-bearing body, by considering an engineering service life of the disaster-bearing body, converting the exceeding rate of earthquake influence intensity for the site into an exceeding probability of site seismic acceleration, to obtain an exceeding probability curve of site seismic acceleration.

3. The method of claim 1, wherein the step of establishing the numerical model of the slope further comprises:
establishing an initial numerical model of the slope based on an actual geology and topography of the slope; and
adjusting parameters of the initial numerical model of the slope to make micro-vibration response-simulated spectrums of adjusted numerical model of the slope close enough to measured microtremor spectrums of the slope, to determine a numerical model of the slope.

4. The method of claim 1, wherein the step of analyzing the anti-seismic capacity of the slope to a given seismic action manner by numerical simulation with the numerical model of the slope, to obtain slope critical seismic accelerations corresponding to different azimuth domains further comprises:
carrying out mesh generation on the numerical model of the slope, wherein an intersection point of meshes is a node, a bottom portion of a slope model is an excitation boundary, and a node on the excitation boundary is an excitation point at which a seismic wave is to income;
acquiring the seismic dynamic action time histories at respective nodes on the excitation boundary at the bottom of the numerical model of the slope according to relevant influencing factors; wherein the relevant influencing factors comprise a seismic phase of an incident wave, an incident angle of the incident wave, an azimuth angle of the incident wave, and a propagation speed of the incident wave;
calculating an initial value of a critical seismic peak acceleration for slope seismic stability by using a pseudo-static method;
based on a principle of ensuring that the slope does not suffer from destabilization caused by dynamic failure, appropriately reducing the initial value of the critical seismic peak acceleration of the slope as calculated by the pseudo-static method, and taking the reduced initial value of the critical seismic peak acceleration as a maximum amplitude of the seismic dynamic action time history to determine the given seismic dynamic action time history for searching the critical seismic peak acceleration of the slope;
gradually increasing an amplitude value of the given seismic dynamic action time history according to an increased amplitude as set, applying the seismic dynamic action time history with the increased amplitude to each node on the excitation boundary at the bottom of the numerical model of the slope according to timing of node starting, and calculating and simulating a seismic dynamic response of the slope corresponding to each step of amplitude increasing by using a dynamic time history method until the slope is subjected to failure and destabilization, thereby obtaining the critical seismic dynamic action time history of the slope; and
taking a peak value of the obtained critical seismic dynamic action time history of the slope as the critical seismic acceleration of the slope corresponding to the given seismic dynamic action time history.

5. The method of claim 4, wherein the step of acquiring the seismic dynamic action time histories at respective nodes on the excitation boundary at the bottom of the numerical model of the slope according to relevant influencing factors further comprises:
establishing a local coordinate system for the numerical model of the slope, wherein the setting of the local coordinate system (x, y, z) for the slope model is that: x and y axes are located in a horizontal plane where the excitation boundary at the bottom of the slope is located, the x or y axis is along a direction with a maximum gradient of the slope, a z axis is vertically upward, the three axes of x, y and z are orthogonal to each other to form a right-hand rectangular coordinate system, a coordinate origin o is located at the node that is earliest disturbed by the seismic waves than any other nodes on the excitation boundary of the slope if the seismic waves are not vertically incident onto the excitation boundary of the slope, and this node is called an initial motion point of the slope, otherwise, the coordinate origin o will be put at the node on a left corner of the excitation boundary opposite to the slope surface;
calculating stress components of incident waves of different seismic phases according to the incident angles and the azimuth angles of the incident waves; wherein the different seismic phases comprise a P wave, an SV wave and an SH wave;
calculating a start timing of the seismic disturbances at respective nodes on the excitation boundary at the bottom of the slope according to the incident angle of the incident wave, the azimuth angle of the incident wave and the propagation speed of the incident wave; and
acquiring the seismic dynamic action time histories at respective nodes on the excitation boundary at the bottom of the numerical model of the slope according to the stress components of incident waves of different seismic phases and the start timing of seismic disturbances at respective nodes on the excitation boundary at the bottom of the slope.

6. The method of claim 5, wherein the step of calculating stress components of incident waves of different seismic phases according to the incident angles of the incident waves and the azimuth angles of the incident waves further comprises:
calculating displacement components of incident waves of different seismic phases according to the incident angles and the azimuth angles of the incident waves; and
calculating stress components of incident waves of different seismic phases according to the displacement components of the incident waves of different seismic phases.

7. The method of claim 5, wherein the step of calculating the start timing of the seismic disturbances at respective nodes on the excitation boundary at the bottom of the slope according to the incident angle of the incident wave, the azimuth angle of the incident wave and the propagation speed of the incident wave further comprises:
calculating a propagation distance of a wavefront of the seismic wave by using equation (1):
rᵢⱼ=lᵢⱼ·sin θ
lᵢⱼ=i·Δx·cos α+j·Δy·sin α (1)
wherein, rᵢⱼ is the propagation distance that the wavefront of the seismic wave passes through from the initial motion point of the slope (i.e., the origin of the local coordinate system of the slope model) to the node (i,j) along a propagation direction of the seismic wave, lᵢⱼ is an apparent distance on the excitation boundary at the bottom of the slope corresponding to the propagation distance rᵢⱼ of the wavefront of the seismic wave, Δx is a grid-edge length in a x-axis direction, Δy is a grid-edge length in a y-axis direction, θ is the incident angle of the seismic wave, and α is the azimuth angle of the seismic wave;
calculating time points at which the seismic waves of different seismic phases reach respective nodes on the excitation boundary at the bottom of the numerical model of the slope by using equation (2) according to the propagation distance of the wavefront of the seismic wave;
$${t}_{ij} = {t}_{0} + \frac{{r}_{ij}}{c} = {t}_{0} + \frac{i \cdot Δ x \cdot cos α + j \cdot Δ y \cdot sin α}{c} \cdot sin θ \qquad ( 2 )$$
wherein, tᵢⱼ is the time point at which the seismic wave of the seismic phase reaches the node (i,j) on the excitation boundary at the bottom of the slope; t₀ is time point at which the seismic wave of the seismic phase reaches the initial motion point on the excitation boundary at the bottom of the slope and is determined according to a distance from a potential hypocenter position to the slope site and the propagation speed of the seismic wave of the seismic phase in a regional crust; and c is an elastic wave velocity of a medium below the excitation boundary of the slope, which is expressed as c_{P} when the wave is a longitudinal wave, and is expressed as c_{S} when the wave is a transverse wave; and
wherein the time points at which the seismic waves of different seismic phases reach respective nodes on the excitation boundary at the bottom of the slope, as calculated by equation (2), are the start timing of the seismic disturbances of different seismic phases at respective nodes on the excitation boundary at the bottom of the slope.

8. The method of claim 5, wherein the step of acquiring the seismic dynamic action time histories at respective nodes on the excitation boundary at the bottom of the numerical model of the slope according to the stress components of incident waves of different seismic phases and the start timing of the seismic disturbances at respective nodes on the excitation boundary at the bottom of the slope further comprises:
superposing the stress component time histories generated by seismic waves of different seismic phase successively arriving at respective nodes according to the start timing of the seismic wave disturbances of different seismic phases at respective nodes on the excitation boundary at the bottom of the slope, namely, taking an algebraic sum of the same stress components corresponding to different seismic phases at respective time points in a duration of the seismic disturbance at each excitation node, to obtain the seismic dynamic action time history of each node on the excitation boundary at the bottom of the slope.

9. A system for acquiring a probability of slope failure and destabilization caused by an earthquake, comprising:
an azimuth division module, configured for performing azimuth division in an area around a site at which a slope is located as a center, to obtain different azimuth domains;
a module for calculating the exceeding probability of site seismic acceleration, configured for pre-setting a grading of value that varies within a certain range, and calculating an exceeding probability that the seismic acceleration of the slope site generated by an earthquake in each azimuth domain is greater than or equal to the seismic acceleration threshold value, to establish an exceeding probability curve of site seismic acceleration corresponding to each azimuth domain;
a module for establishing a slope numerical model, configured for establishing a numerical model of the slope;
a module for calculating a slope critical seismic acceleration, configured for acquiring slope critical seismic accelerations corresponding to different seismic action manners acting on the slope numerical model; where the seismic action manners comprise an intensity, frequency and duration of the seismic motion as well as a nature, directions and phase differences of the seismic action forces, and relevant influencing factors mainly comprise a seismic phase of the incident wave, an incident angle of the incident wave, an azimuth angle of the incident wave, and a propagation speed of the incident wave; and
a module for calculating a probability of slope failure and destabilization caused by an earthquake, configured for determining a probability of slope failure and destabilization caused by an earthquake according to the exceeding probability curve of slope-site seismic acceleration and the slope critical seismic accelerations, and calculating a slope seismic stability coefficient.
